(19) United States
(12) Patent Application Publication
(10) Pub. No.: US 2006/0291240 A1
(43) Pub. Date: Dec. 28, 2006

(54) Backlight assembly, display device having the same, and method thereof

(76) Inventors: Jae-Kwang Kim, Seoul (KR); Young-Bee Chu, Suwon-si (KR); Dong-Cheol Kim, Suwon-si (KR); Kyu-Seok Kim, Gyeonggi-do (KR); Sung-Min Kim, Yongin-si (KR); Jeung-Soo Kim, Yongin-si (KR); Hyung-Guel Kim, Yongin-si (KR); Sang-Hee Lee, Yongin-si (KR); Jeong-Seok Oh, Seoul (KR); Jae-Lok Cha, Goyang-si (KR)

Correspondence Address: CANTOR COLBURN, LLP, 55 GRIFFIN ROAD SOUTH, BLOOMFIELD, CT, 06002, US

(21) Appl. No.: 11/451,232

(22) Filed: Jun. 12, 2006

(30) Foreign Application Priority Data
Aug. 4, 2005 (KR) 2005-71258
Jul. 19, 2005 (KR) 2005-65285
Jun. 13, 2005 (KR) 2005-50511
Jul. 15, 2005 (KR) 2005-64443
Oct. 19, 2005 (KR) 2005-98448

(51) Int. Cl. F21V 7/04

(52) U.S. Cl. 362/600

(57) ABSTRACT

A backlight assembly supplies a guided light to a display panel having a main display part on which a main image is selectively displayed, and a sub display part on which a sub image is constantly displayed. The backlight assembly includes a light source and a light guiding unit. The light source generates a light. The light guiding unit includes a light incident surface, a light exiting surface, and a corresponding surface. The light from the light source is incident into the light incident surface. The light exiting surface has a main region and a sub region, the sub region having an optical pattern increasing a luminance of the light. The guided light exits the light exiting surface. The corresponding surface corresponds to the light exiting surface. A luminance uniformity and a luminance when viewed on a plane are increased.

The present application claims priority to Korean Patent Applications No. 2005-50511, filed on Jun. 13, 2005, Korean Patent Application No. 2005-64443, filed on Jul. 15, 2005, Korean Patent Application No. 2005-65285, filed on Jul. 19, 2005, Korean Patent Application No. 2005-71258, filed on Aug. 4, 2005, and Korean Patent Application No. 2005-98448, filed on Oct. 19, 2005 and all the benefits accruing therefrom under 35 U.S.C. §119, and the contents of which in their entireties are herein incorporated by reference.

### BACKGROUND OF THE INVENTION

1. Field of the Invention

The present invention relates to a backlight assembly, a display device having the backlight assembly, and a method thereof. More particularly, the present invention relates to a backlight assembly capable of increasing a luminance uniformity and a luminance when viewed on a plane, a display device having the backlight assembly, and a method of controlling luminance of a display panel provided with light from the backlight assembly.

2. Description of the Related Art

A liquid crystal display (“LCD”) device, in general, is used for a personal computer, a notebook computer, an automobile navigation system, a television receiver set, etc. The LCD device converts an electric signal having image information into an image. The LCD device has various characteristics such as a light weight structure, a small size, thin thickness, low power consumption, etc.

In a mobile LCD device, the LCD device is divided into a main display part and a sub display part to improve optical characteristics and to decrease power consumption. For example, in a selective-state driving mode, auxiliary information such as time, data, battery state, etc., are displayed in the sub display part, and main information such as an image, character, etc., are displayed in the main display part. In a constant-state driving mode, only the auxiliary information is displayed in the sub display part, and the main display part is turned off.

The LCD device is a non-emissive type display device and therefore requires a light source outside of the display panel, such as a backlight assembly. The information is displayed on the main display part and the sub display part using a light generated from the light source.

The backlight assembly requires large power consumption. In order to decrease the power consumption of the backlight assembly, a luminance of the backlight assembly is decreased in the constant-state mode, thereby deteriorating an image display quality of the image displayed on the sub display part.

When the luminance of the backlight assembly is increased in order to improve the image display quality, the power consumption of the backlight assembly is also increased.

### BRIEF SUMMARY OF THE INVENTION

Exemplary embodiments of the present invention provide a backlight assembly capable of increasing a luminance uniformity and a luminance when viewed on a plane.

Exemplary embodiments of the present invention also provide a display device having the above-mentioned backlight assembly.

Exemplary embodiments of the present invention also provide a method of controlling luminance of a display panel receiving light from the above-mentioned backlight assembly.

A backlight assembly in accordance with exemplary embodiments of the present invention supplies a display panel having a main display part on which a main image is selectively displayed, and a sub display part on which a sub image is constantly displayed with a guided light. The backlight assembly includes a light source and a light guiding unit. The light source generates a light. The light guiding unit includes a light incident surface, a light exiting surface, and a corresponding surface. The light from the light source is incident into the light incident surface. The light exiting surface has a main region and a sub region, the sub region having an optical pattern increasing a luminance of the light from the light source. The guided light exits the light exiting surface. The corresponding surface corresponds to the light exiting surface.

The optical pattern may include a plurality of first prisms or a plurality of embossing patterns. The plurality of first prisms may have a substantially triangular shape. A light scattering pattern or a plurality of second prisms may be formed on the corresponding surface. The light scattering pattern corresponding to the main region may have a lower density than the light scattering pattern corresponding to the sub region. The main region of the light exiting surface may have a substantially flat surface. The main region may be adjacent the light incident surface and the sub region may be spaced apart from the light incident surface. The corresponding surface may be a light reflecting surface.

A backlight assembly in accordance with exemplary embodiments of the present invention supplies a display panel having a main display part on which a main image is selectively displayed, and a sub display part on which a sub image is constantly displayed with a light. The backlight assembly includes a light source, a light guiding unit, a first optical sheet, and a second optical sheet. The light source generates a light. The light guiding unit includes a light incident surface into which the light from the light source is incident, and a light exiting surface having a main region and a sub region, the guided light exiting the light exiting surface. The first optical sheet is on the main region increasing a luminance of the guided light exiting the main region by a first luminance increasing rate. The second optical sheet is on the sub region increasing a luminance of the guided light exiting the sub region by a second luminance increasing rate that is greater than the first luminance increasing rate.

The first optical sheet may also cover the sub region, and the second optical sheet may overlap the first optical sheet. The second optical sheet may include a dual brightness enhancement film or a brightness enhancement sheet.

A backlight assembly in accordance with still other exemplary embodiments of the present invention supplies a display panel having a main display part on which a main image is selectively displayed, and a sub display part on which a sub image is constantly displayed with a guided light. The backlight assembly includes a first light source, a second light source, and a light guiding unit. The first light source generates a first light in a selective-state driving mode and is adjacent to the main display part. The second light source generates a second light in a constant-state driving mode and is adjacent to the sub display part. The light guiding unit guides the first and second lights to supply the display panel with the guided light.

Each of the first and second light sources may include a light-emitting diode (“LED”). The light guiding unit may include a light exiting surface including a main region corresponding to the main display part and a sub region corresponding to the sub display part, a first side surface connected to the main region and adjacent to the first light source, and a second side surface connected to the sub region and adjacent to the second light source. The light guiding unit may include a main light guiding plate corresponding to the main display part and adjacent to the first light source, and a sub light guiding plate corresponding to the sub display part and adjacent to the second light source.

A display device in accordance with exemplary embodiments of the present invention includes a light source, a light guiding unit, and a display panel. The light source generates a light. The light guiding unit includes a light incident surface and a light exiting surface. The light is incident into the light incident surface. The light exiting surface has a main region and a sub region, the sub region having an optical pattern increasing a luminance of the light. A guided light exits the light exiting surface. The display panel has a main display part on which a main image is displayed based on the guided light exiting the main region of the light exiting surface, and a sub display part on which a sub image is displayed based on the guided light exiting the sub region of the light exiting surface.

A display device in accordance with other exemplary embodiments of the present invention includes a light source, a light guiding unit, a first optical sheet, a second optical sheet, and a display panel. The light source generates a light. The light guiding unit includes a light incident surface into which the light is incident, and a light exiting surface having a main region and a sub region, a guided light exiting the light exiting surface. The first optical sheet is on the main and sub regions increasing a luminance of the guided light exiting the main and sub regions by a first luminance increasing ratio. The second optical sheet is on the sub region increasing a luminance of the guided light exiting the sub region by a second luminance increasing ratio that is greater than the first luminance increasing ratio. The display panel has a main display part on which a main image is displayed based on the guided light exiting the main region of the light exiting surface, and a sub display part on which a sub image is displayed based on the guided light exiting the sub region of the light exiting surface.

A display device in accordance with still other exemplary embodiments of the present invention includes a display panel, a backlight assembly, and a driving circuit. The display panel includes a main display part on which a main image is selectively displayed, and a sub display part on which a sub image is constantly displayed. The backlight assembly includes a first light source, a second light source, and a light guiding unit. The first light source is adjacent to the main display part and generates a first light. The second light source is adjacent to the sub display part and generates a second light. The light guiding unit guides the first and second lights toward the display panel. The driving circuit part applies an electric power to the first light source in a selective-state driving mode, and applies an electric power to the second light source in a constant-state driving mode.

A display device in accordance with still other exemplary embodiments of the present invention includes a display panel, a backlight assembly, and a driving circuit. The display panel includes a main display part on which a main image is selectively displayed, and a sub display part on which a sub image is constantly displayed. The backlight assembly includes a point light source and a light guiding unit. The point light source is adjacent to the sub display part and generates a light. The light guiding unit guides the light toward the display panel. The driving circuit part applies a first electric power to the point light source in a selective-state driving mode, and applies a second electric power to the point light source in a constant-state driving mode.

The driving circuit part may be electrically connected to the display panel, and the driving circuit part may apply a first driving signal to the display panel in the selective-state driving mode to display the main image, and may apply a second driving signal to the display panel in the constant-state driving mode to display the sub image.

A method of controlling luminance in a display panel having a sub display part and a main display part in accordance with exemplary embodiments of the present invention includes providing a luminance enhancing element relative to a sub region of a light guiding unit in a backlight assembly and reducing power consumption in the backlight assembly from a first level during a selective-state driving mode to a second level during a constant-state driving mode, wherein luminance of the sub display part is not substantially reduced during the constant-state driving mode.

Providing a luminance enhancing element may include forming an optical pattern on the sub region but not on the main region of the light guiding unit, disposing a second optical sheet in an area corresponding to the sub region of the light guiding unit but not in an area corresponding to a main region of the light guiding unit, or arranging a light source adjacent the sub region of the light guiding unit. In the case of arranging a light source, the method may further include providing a first electric power to the light source in the selective-state driving mode and a lower second electric power to the light source in the constant-state driving mode. A light source may further be arranged adjacent a main region of the light guiding unit, and the method may further include applying a first electric power to the light source adjacent the main region during the selective state driving mode, and applying a second electric power to the light source adjacent the sub region during the constant-state driving mode.

According to the present invention, the luminance of the sub region in the constant-state driving mode is increased. Therefore, power consumption of the backlight assembly and the display device is decreased, and an image display quality of the sub region is improved.

### BRIEF DESCRIPTION OF THE DRAWINGS

The above and other advantages of the present invention will become more apparent by describing in detail exemplary embodiments thereof with reference to the accompanying drawings, in which:

FIG. 1 is a cross-sectional view illustrating an exemplary backlight assembly in accordance with an exemplary embodiment of the present invention;

FIG. 2 is a cross-sectional view illustrating an exemplary backlight assembly in accordance with another exemplary embodiment of the present invention;

FIG. 3 is a cross-sectional view illustrating an exemplary backlight assembly in accordance with another exemplary embodiment of the present invention;

FIG. 4 is a cross-sectional view illustrating an exemplary backlight assembly in accordance with another exemplary embodiment of the present invention;

FIG. 5 is an exploded perspective view illustrating an exemplary backlight assembly in accordance with another exemplary embodiment of the present invention;

FIG. 6 is a cross-sectional view taken along line I-I′ shown in FIG. 5;

FIG. 7 is an exploded perspective view illustrating an exemplary backlight assembly in accordance with another exemplary embodiment of the present invention;

FIG. 8 is a perspective view illustrating an exemplary backlight assembly in accordance with another exemplary embodiment of the present invention;

FIG. 9A is a timing diagram illustrating driving signals applied to a first and second diode of the exemplary backlight assembly of FIG. 8 in a selective-state driving mode;

FIG. 9B is a graph illustrating a luminance of a light passing through a light guiding unit of the exemplary embodiment of the backlight assembly measured along line II-II′ of FIG. 8 in a selective-state driving mode;

FIG. 10A is a timing diagram illustrating driving signals applied to a first and second diode of the exemplary embodiment of the backlight assembly of FIG. 8 in a constant-state driving mode;

FIG. 10B is a graph illustrating a luminance of a light passing through a light guiding unit of the exemplary embodiment of the backlight assembly measured along line II-II′ of FIG. 8 in a constant-state driving mode;

FIG. 11 is a perspective view illustrating an exemplary backlight assembly in accordance with another exemplary embodiment of the present invention;

FIG. 12 is an exploded perspective view illustrating the exemplary embodiment of the backlight assembly shown in FIG. 11;

FIG. 13 is a cross-sectional view taken along line III-III′ shown in FIG. 12;

FIG. 14 is an exploded perspective view illustrating an exemplary backlight assembly in accordance with another exemplary embodiment of the present invention;

FIG. 15 is a cross-sectional view taken along line IV-IV′ shown in FIG. 14;

FIG. 16 is a cross-sectional view illustrating an exemplary display device in accordance with another exemplary embodiment of the present invention;

FIG. 17 is an exploded perspective view illustrating an exemplary display device in accordance with another exemplary embodiment of the present invention;

FIG. 18 is a cross-sectional view taken along line V-V′ shown in FIG. 17;

FIG. 19 is a perspective view illustrating an exemplary display device in accordance with another exemplary embodiment of the present invention;

FIG. 20 is an exploded perspective view illustrating the exemplary embodiment of the display device shown in FIG. 19;

FIG. 21 is a cross-sectional view taken along line VI-VI′ shown in FIG. 20;

FIG. 22 is an exploded perspective view illustrating an exemplary display device in accordance with another exemplary embodiment of the present invention;

FIG. 23 is a cross-sectional view taken along line VII-VII′ shown in FIG. 22;

FIG. 24 is an exploded perspective view illustrating an exemplary display device in accordance with another exemplary embodiment of the present invention;

FIG. 25 is a cross-sectional view taken along line VIII-VIII′ shown in FIG. 24;

FIGS. 26A and 26B are graphs illustrating a relationship between driving signals applied to exemplary light-emitting diodes (“LEDs”) and power consumption;

FIG. 27A is an image illustrating a luminance of a light exiting an exemplary light guiding unit when an exemplary LED is adjacent to a main region of the light guiding unit; and

FIG. 27B is an image illustrating a luminance of a light exiting an exemplary light guiding unit when an exemplary LED is adjacent to a sub region of the light guiding unit.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

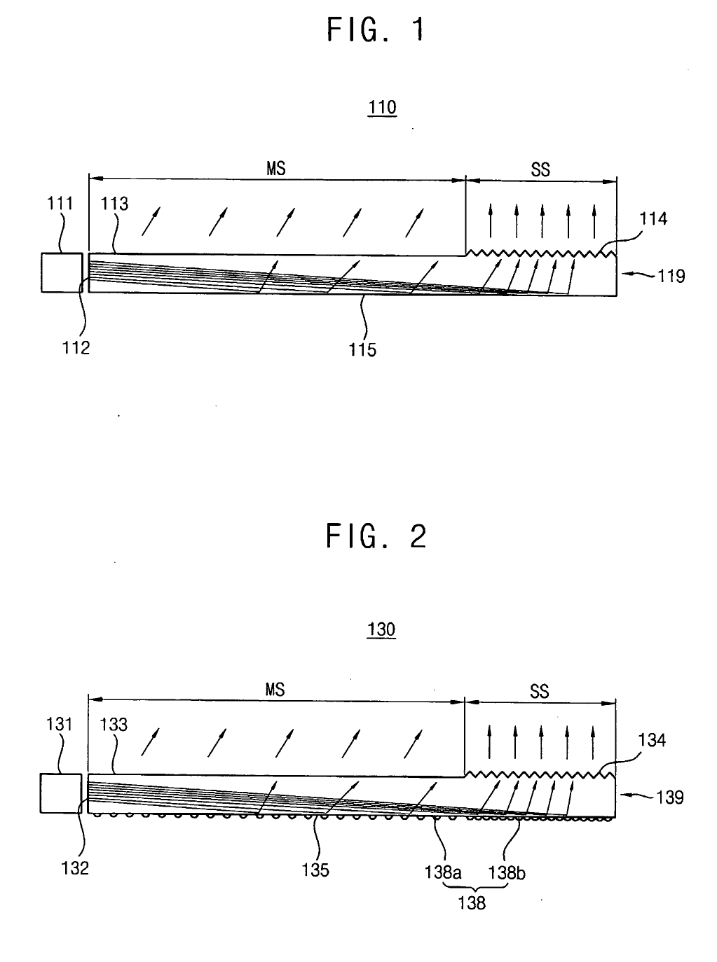

FIG. 1 is a cross-sectional view illustrating an exemplary backlight assembly in accordance with an exemplary embodiment of the present invention.

Referring to FIG. 1, the backlight assembly 110 supplies a display panel (not shown), including a main display part and a sub display part, with a light. A main image is selectively displayed on the main display part. A sub image is constantly displayed on the sub display part. The backlight assembly 110 includes a light source and a light guiding unit 119.

In FIG. 1, the light source includes a light-emitting diode (“LED”) 111. Alternatively, the light source may be a fluorescent lamp or other suitable light source. A luminance uniformity of both the light-emitting diode 111 and the fluorescent lamp is poor, therefore the backlight assembly 110 includes a plurality of optical units to improve optical characteristics.

The light guiding unit 119 guides the light generated from the LED 111 or other light source, and changes the light of a point type or a linear type into a light of a surface type. The light guiding unit 119 includes a light incident surface 112, a light exiting surface 113, and a corresponding surface 115 opposite the light exiting surface 113.

The light generated from the LED 111 is incident into the light guiding unit 119 through the light incident surface 112. The light guided by the light guiding unit 119 exits the light guiding unit 119 through the light exiting surface 113. The light exiting surface 113 includes a main region MS and a sub region SS. In FIG. 1, the main region MS is adjacent to the light incident surface 112, and the sub region SS is spaced apart from the light incident surface 112. The main region MS is substantially in parallel with the sub region SS. That is, the main region MS is substantially co-planar with the sub region SS. The main region MS is interposed between the light incident surface 112 and the sub region SS. A portion of the light exiting surface 113 corresponding to the main region MS has a flat surface, such as a planar or substantially planar surface. An optical pattern 114 is formed in the light exiting surface 113 corresponding to the sub region SS to increase a luminance corresponding to the sub region SS. That is, the main and sub regions MS and SS have different patterns from each other. The corresponding surface 115 corresponds to the light exiting surface 113. The light incident surface 112 connects the light exiting surface 113 to the corresponding surface 115.

The light guiding unit 119 has a substantially flat plate shape having a substantially constant thickness. Alternatively, the light guiding unit 119 may have a wedge shape. In the wedge shape, a thickness of the light guiding unit 119 is decreased, as a distance from the light incident surface 112 is increased. Thus, the thickness of the light guiding unit 119 towards the sub region SS would be thinner than a thickness of the light guiding unit 119 in the main region MS in the wedge shape.

The light guiding unit 119 may include a light guiding material having various characteristics such as high light transmittance, high heat resistance, high chemical resistance, high mechanical strength, high light diffusibility, etc. The light guiding unit 119 may include a matrix and a plurality of particles in the matrix. Examples of a material that can be used for the matrix of the light guiding unit 119 include polymethylmethacrylate, polyamide, polyimide, polypropylene, polyurethane, etc. The particles of the light guiding unit 119 may be transparent. Alternatively, the light guiding unit 119 may include an acryl-based resin.

The optical pattern 114 is integrally formed with the light guiding unit 119 in the sub region SS. In particular, the optical pattern 114 may have a plurality of first prisms having a substantially triangular cross-sectional shape. The first prisms are arranged by a constant pitch. The first prisms are substantially parallel with each other. The first prisms may be substantially parallel with a side of the light guiding unit 119. Alternatively, each of the first prisms may have a rounded corner. The first prisms may be formed through an extraction process, a molding process, etc., so that the first prisms are integrally formed with the light guiding unit 119. Alternatively, the first prisms may also be printed onto the light guiding unit 119.

The light incident into the light guiding unit 119 through the light incident surface 112 is repetitively reflected between the corresponding surface 115 and the light exiting surface 113 so that the light is incident into an end portion of the light guiding unit 119. A luminance of the light incident into the light guiding unit 119 is decreased during the repetitive reflection. That is, the light in the main region MS has a smaller loss than the light in the sub region SS. An exiting angle of the light exiting the main region MS forms an angle of about 75° to about 83° with respect to a normal direction that is substantially perpendicular to the light exiting surface 113 of the light guiding unit 119.

The light exiting the main region MS has a smaller loss than the light exiting the sub region SS so that a luminance of the light exiting the sub region SS is smaller than that of the light exiting the main region MS.

The optical pattern 114 guides the light exiting the light exiting surface 113 in the sub region SS of the light guiding unit 119 so that the luminance of the sub region SS when viewed on a plane is increased. Therefore, the light exiting the sub region SS may have substantially the same luminance as the light exiting the main region MS.

The backlight assembly 110 includes a selective-state driving mode and a constant-state driving mode. The constant-state driving mode has lower power consumption than the selective-state driving mode. In the constant-state driving mode, the electric power applied to the LED 111 is small so that the luminance of the LED 111 is small, thereby the luminance of the image displayed in the sub region SS is decreased.

However, in FIG. 1, the optical pattern 114 in the sub region SS increases the luminance when viewed in a plane to increase the luminance of the image displayed in the sub region SS. Therefore, the optical pattern 114 converts the light emitting from the sub region SS into a light that is suitable for a display device that is driven independently, thereby improving an image display quality in the sub region SS.

FIG. 2 is a cross-sectional view illustrating an exemplary backlight assembly 130 in accordance with another exemplary embodiment of the present invention.

The backlight assembly 130 of FIG. 2 is substantially the same as in FIG. 1 except for a light guiding unit 139. Thus, any further explanation concerning the same or like parts as those described in FIG. 1 will be omitted.

Referring to FIG. 2, the light guide unit 139 is substantially the same as the light guide unit 119 in FIG. 1 except that a light scattering pattern 138 is additionally formed on a corresponding surface 135 of the light guiding unit 139.

The light scattering pattern 138 has a plurality of dot shapes. For example, the light scattering pattern 138 may have embossing patterns. The light from light source 131 incident into the light guiding unit 139 through a light incident surface 132 is repetitively reflected between the corresponding surface 135 and a light exiting surface 133 so that the light passes through the light guiding unit 139 toward a sub region SS of the light guiding unit 139. A luminance of the light incident into the light guiding unit 139 is decreased during the repetitive reflection. The light scattering pattern 138 decreases a light exiting angle of the light exiting the sub region SS to increase a luminance of the sub region SS. Light exits the sub region SS through the optical pattern 134.

The light scattering pattern 138 may be formed through a mechanical process such as a printing process. For example, the dot shapes of the light scattering pattern 138 may have various sizes of about ten micrometers to about one hundred micrometers. The light scattering pattern 138 may be formed in the main and sub regions MS and SS. The light scattering pattern 138a of the main region MS may have a lower density than the light scattering pattern 138b of the sub region SS.

The light scattering pattern 138 in the main and sub regions MS and SS may be adjusted to control the luminances in the main and sub regions MS and SS. For example, size and density of the dot shapes of the light scattering pattern 138a in the main region MS are smaller than those of the dot shapes of the light scattering pattern 138b in the sub region SS.

Therefore, the loss of the light in the sub region SS is compensated by the light scattering pattern 138 to increase a luminance uniformity of the backlight assembly 130.

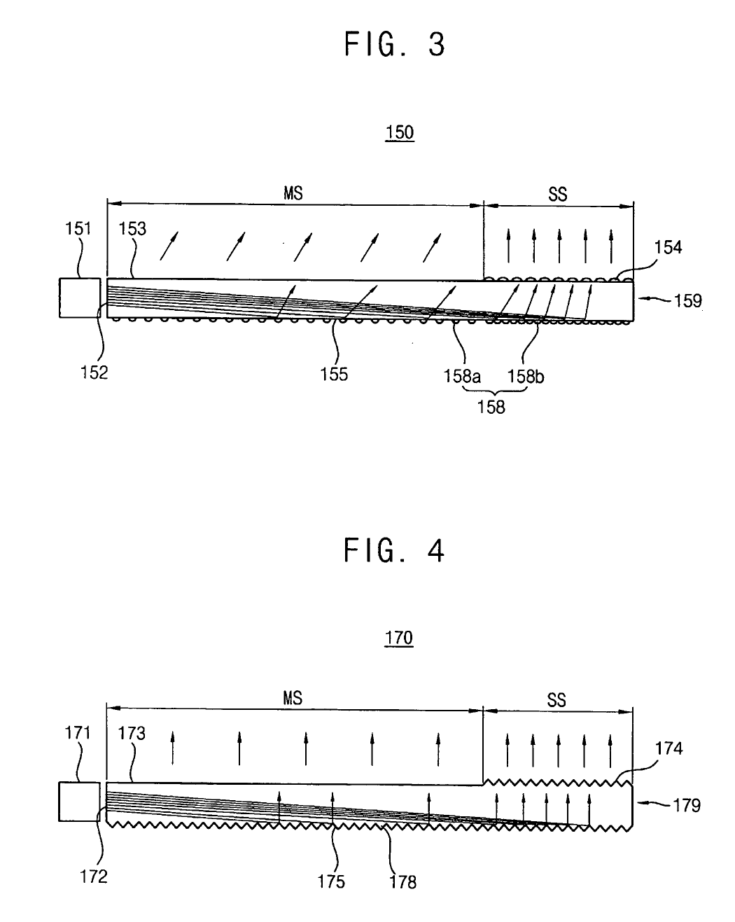

FIG. 3 is a cross-sectional view illustrating an exemplary backlight assembly 150 in accordance with another exemplary embodiment of the present invention.

The backlight assembly 150 of FIG. 3 is substantially the same as in FIG. 1 except that the shape of the optical pattern 154 of the light guiding unit 159 is different from that of the light guiding unit 119, and the light guiding unit 159 includes a light scattering pattern 158 similar to the light scattering pattern 138 of FIG. 2. Thus, any further explanation concerning the same or like parts as those described in FIG. 1 will be omitted.

Referring to FIG. 3, an optical pattern 154 is formed on a light exiting surface 153 of the light guiding unit 159. Light from light source 151 is incident on the light incident surface 152 of the light guiding unit 159 and may be repetitively reflected between the corresponding surface 155 and the light exiting surface 153. The light scattering pattern 158 decreases a light exiting angle of the light exiting the sub region SS to increase a luminance of the sub region SS. The light scattering pattern 158a of the main region MS may have a lower density than the light scattering pattern 158b of the sub region SS. Light exits the sub region SS through the optical pattern 154. The optical pattern 154 has a plurality of dot shapes. For example, the optical pattern 154 may have embossing patterns.

Each of the dot shapes of the optical pattern 154 functions as a convex lens to increase a luminance of a sub region SS when viewed on a plane. The optical pattern 154 may be formed through a printing process on the sub region SS after manufacturing the light guiding unit 159 through a molding process.

Each of the dot shapes may have a substantially hemi-circular cross-section or a substantially hemi-elliptical cross-section. In FIG. 3, a center of gravity of each of the dot shapes may correspond to an apex of each of the dot shapes to increase the luminance when viewed on a plane. In FIG. 3, each of the dot shapes is protruded from the light exiting surface 153. Alternatively, each of the dot shapes may be recessed from the light exiting surface 153.

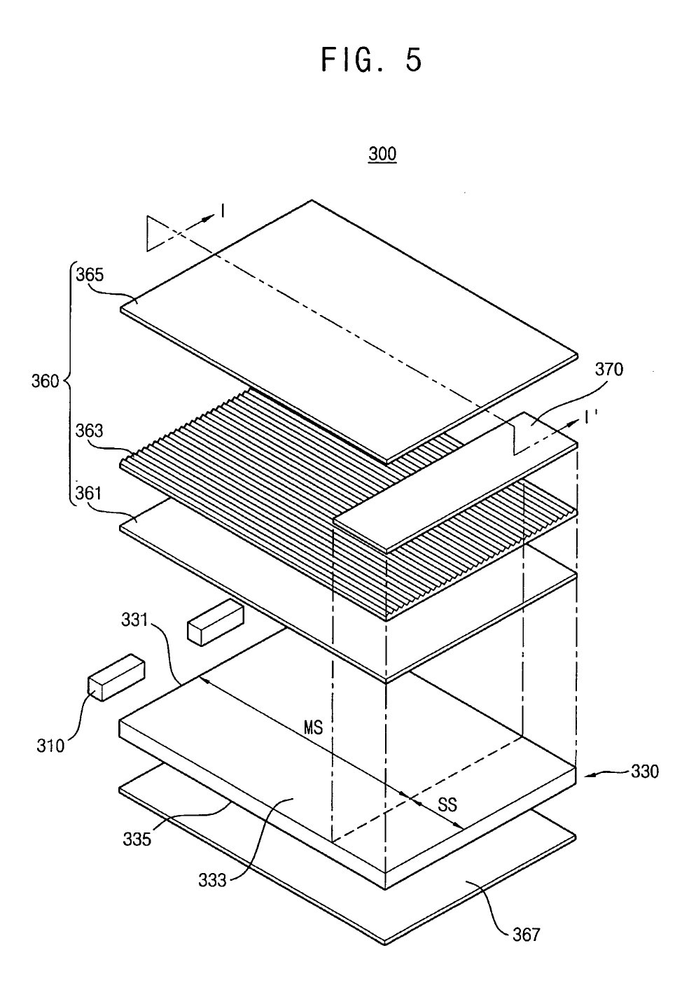

FIG. 4 is a cross-sectional view illustrating an exemplary backlight assembly 170 in accordance with another exemplary embodiment of the present invention.

The backlight assembly 170 of FIG. 4 is substantially the same as in FIG. 1 except that a brightness enhancement pattern 178 is additionally formed on a corresponding surface 175 of a light guiding unit 179. Thus, any further explanation concerning the same or like parts as those described in FIG. 1 will be omitted.

Referring to FIG. 4, the brightness enhancement pattern 178 is formed on the corresponding surface 175 of the light guiding unit 179. While the optical pattern 174 includes a plurality of first prisms, the brightness enhancement pattern 178 includes a plurality of second prisms. Each of the second prisms may be protruded or recessed from the corresponding surface 175, which is opposite the light exiting surface 173 of the light guiding unit 179. The brightness enhancement pattern 178 guides the light from light source 171 incident into incident surface 172 of the light guiding unit 179 toward a front of the backlight assembly 170.

The second prisms of the brightness enhancement pattern 178 in the main region MS have a lower pitch than the second prisms of the brightness enhancement pattern 178 in the sub region SS.

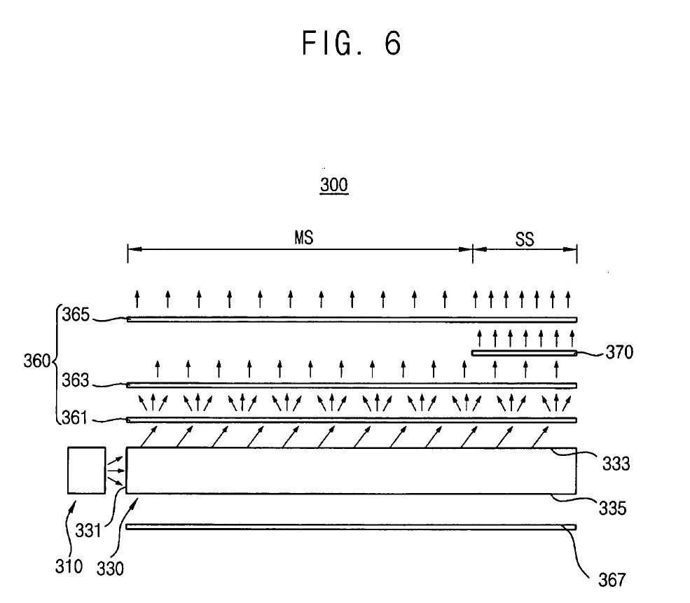

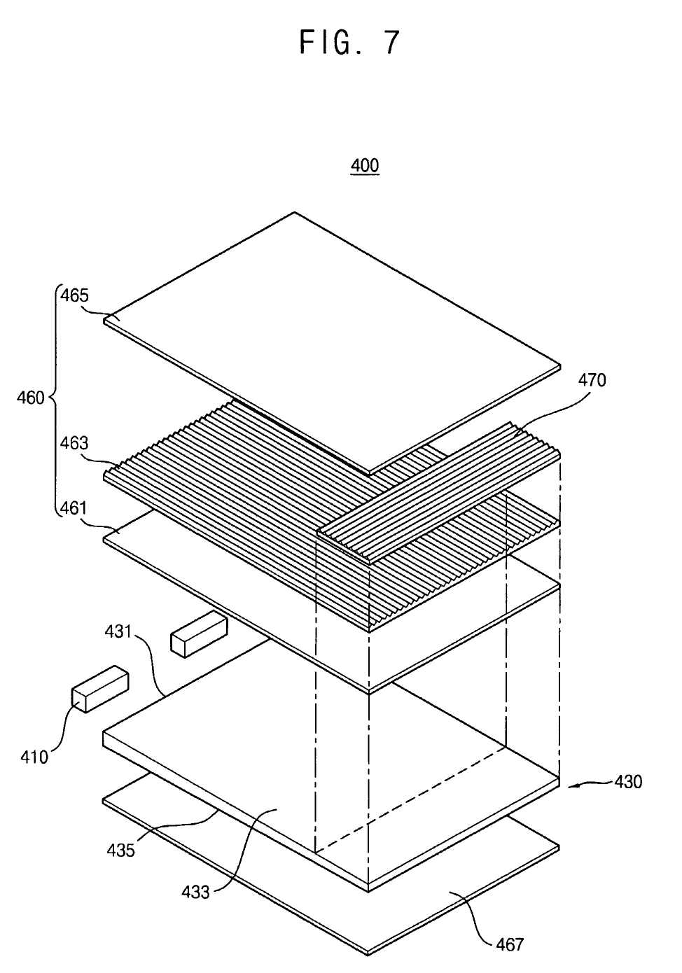

FIG. 5 is an exploded perspective view illustrating an exemplary backlight assembly in accordance with another exemplary embodiment of the present invention. FIG. 6 is a cross-sectional view taken along line I-I′ shown in FIG. 5.

Referring to FIGS. 5 and 6, the backlight assembly 300 includes a light source 310, a light guiding unit 330, a first optical sheet 360, and a second optical sheet 370.

The light source 310 of FIGS. 5 and 6 may be the same as the LED 111 described with respect to FIG. 1. Thus, any further explanation concerning the light source 310 will be omitted.

The light guiding unit 330 guides the light generated from an LED of the light source 310, and changes the light of a point type or a linear type into a light of a surface type. The light guiding unit 330 includes a light incident surface 331, a light exiting surface 333 and a corresponding surface 335.

The light generated from the LED of the light source 310 is incident into the light guiding unit 330 through the light incident surface 331. The light guided by the light guiding unit 330 exits the light guiding unit 330 through the light exiting surface 333. The light exiting surface 333 includes a main region MS and a sub region SS. The main region MS is adjacent to the sub region SS and is substantially parallel to the main region MS. That is, the main region MS may be substantially coplanar with the sub region SS. The corresponding surface 335 corresponds oppositely to the light exiting surface 333. In FIGS. 5 and 6, the light guiding unit 330 has a substantially flat shape.

The first optical sheet 360 covers the main and sub regions MS and SS to improve optical characteristics such as a luminance uniformity, a luminance when viewed on a plane, etc., of the light exiting the light guiding unit 330 through the light exiting surface 333. A luminance increasing ratio is a ratio of a luminance of an incident light to a luminance of an exiting light. The first optical sheet 360 has a first luminance increasing ratio. In FIGS. 5 and 6, the first optical sheet 360 is on the main and sub regions MS and SS. Alternatively, the first optical sheet 360 may be only on the main region MS. The first optical sheet 360 includes a diffusion sheet 361 and a brightness enhancement sheet 363.

The diffusion sheet 361 may be positioned between the light guiding unit 330 and the brightness enhancement sheet 363, and diffuses the light exiting the main and sub regions MS and SS of the light guiding unit 330 to increase the luminance of the light. The diffusion sheet 361 includes a base body, a plurality of diffusion beads (not shown) and a binder. The diffusion beads are on the base body to diffuse the light. The diffusion beads are attached to the base body through the binder. Alternatively, the diffusion beads may be in the base body, such as integrated therein.

The brightness enhancement sheet 363 is on the diffusion sheet 361. The brightness enhancement sheet 363 increases the luminance of the light when viewed on a plane. A plurality of prisms is formed on the brightness enhancement sheet 363. The prisms of the brightness enhancement sheet 363 are substantially parallel with one another. A longitudinal direction of each of the prisms is substantially perpendicular to the light incident surface 331. In other words, the prisms of the brightness enhancement sheet 363 extend in a direction parallel to a direction extending from the light incident surface 331 to an opposite side surface of the light guiding unit 330.

That is, the brightness enhancement sheet 363 has an irregular surface comprising ridges and grooves. When the brightness enhancement sheet 363 has the prisms, the brightness enhancement sheet 363 guides the light toward the front of the backlight assembly 300, and the luminance of the light when viewed on a plane is increased.

The first optical sheet 360 may further include a reflecting sheet 367 and a protecting sheet 365. The reflecting sheet 367 is on the corresponding surface 335 of the light guiding unit 330 so that a portion of the light leaked from the corresponding surface 335 is reflected from the reflecting sheet 367 back toward the light guiding unit 330, thereby increasing the luminance of the backlight assembly 300. The reflecting sheet 367 may include a highly reflective material.

The protecting sheet 365 is on the brightness enhancement sheet 363 to protect the brightness enhancement sheet 363 from scratches.

The second optical sheet 370 is interposed between the brightness enhancement sheet 363 and the protecting sheet 365 corresponding to the sub region SS, but not in an area corresponding to the main region MS. The second optical sheet 370 increases a luminance of the light exiting the sub region SS. The second optical sheet 370 has a second luminance increasing ratio that is greater than the first luminance increasing ratio of the first optical sheet 360.

In FIGS. 5 and 6, the second optical sheet 370 includes a dual brightness enhancement film (“DBEF”) that enhances the brightness two times such as is available by 3M Company, USA.

The light incident into the second optical sheet 370 includes a P-wave portion and an S-wave portion. The second optical sheet 370 changes a vibration direction of the S-wave portion so that the P-wave and S-wave portions vibrate in substantially the same direction. A polarizer (not shown) transmits only the P-wave portion, and blocks the S-wave portion to decrease the luminance of the backlight assembly 300. However, the second optical sheet 370 changes the vibration direction of the S-wave portion to increase the luminance of the backlight assembly 300 although the light having passed through the second optical sheet 370 is incident into the polarizer (not shown). The luminance of the sub region SS of the backlight assembly 300 having the second optical sheet 370 may be increased by two times compared to a backlight assembly not having the second optical sheet 370.

The backlight assembly 300 may be used for a light generating unit of a display device having a display panel (not shown). The display panel (not shown) may include the polarizer (not shown). In addition, the display panel (not shown) may have a main display part corresponding to the main region MS and a sub display part corresponding to the sub region SS.

In a constant-state driving mode, the backlight assembly 300 is operated at a lower electric power than during a selective-state driving mode. That is, the LED of the light source 310 is operated at the lower electric power in the constant-state driving mode than during the selective-state driving mode so that the luminance of the backlight assembly 300 is decreased, thereby decreasing an image display quality in the constant-state driving mode.

However, in FIGS. 5 and 6, the second optical sheet 370 is disposed on the sub region SS to increase the luminance of the sub region SS, thereby increasing the image display quality of the sub region SS in the constant-state driving mode.

FIG. 7 is an exploded perspective view illustrating an exemplary backlight assembly 400 in accordance with another exemplary embodiment of the present invention.

The backlight assembly 400 of FIG. 7 is substantially the same as in FIGS. 5 and 6 except for a light guiding unit 430 and a second optical sheet 470. Thus, any further explanation concerning the same or like parts as those described in FIGS. 5 and 6 will be omitted.

Referring to FIG. 7, the light guiding unit 430 has a wedge shape. That is, a thickness of the light guiding unit 430 is decreased, as a distance from a light incident surface 431 of the light guiding unit 430 is increased. Light from light source 410 is directed to the light incident surface 431. Due to the wedge shape, the light exiting surface 433 and the corresponding surface 435 are not parallel to each other, and are spaced further apart adjacent the light incident surface 431, and spaced closer together adjacent an end portion of the light guiding unit 430 opposite the light incident surface 431. In FIG. 7, the light guiding unit 430 has the wedge shape to increase a luminance of the backlight assembly 400. The reflecting sheet 467 may be disposed below the corresponding surface 435 as shown.

The second optical sheet 470 is on a brightness enhancement sheet 463 and below a protection sheet 465 of the first optical sheet 460 corresponding to a sub region SS. The second optical sheet 470 increases a luminance of the light exiting the sub region SS.

The second optical sheet 470 includes a plurality of prisms. The prisms are substantially parallel with each other. The prisms of the second optical sheet 470 may be substantially perpendicular to the prisms of the brightness enhancement sheet 463.

The diffusion sheet 461 and the brightness enhancement sheet 463 firstly increase the luminance when viewed on a plane, and the second optical sheet 470 secondly increases the luminance of the sub region SS when viewed on a plane, thereby increasing the luminance when viewed on a plane in the sub region SS.

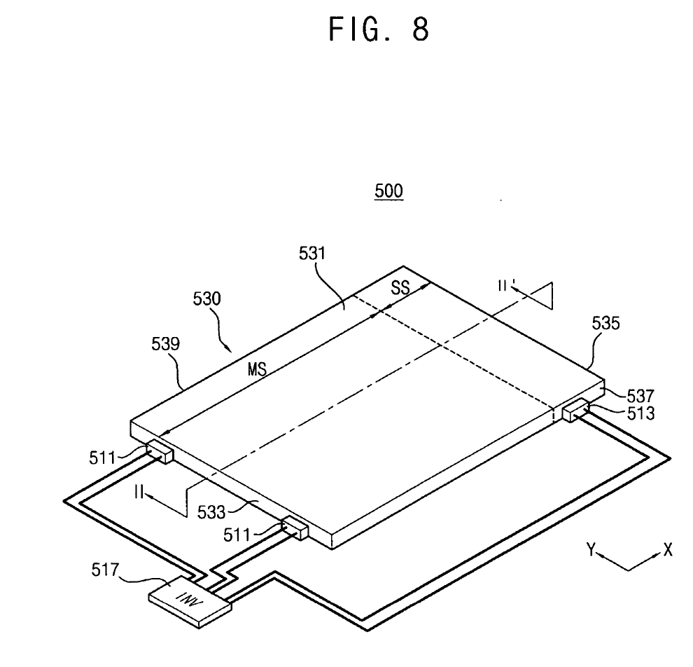

FIG. 8 is a perspective view illustrating an exemplary backlight assembly 500 in accordance with another exemplary embodiment of the present invention.

Referring to FIG. 8, the backlight assembly 500 includes a first light source, a second light source, and a light guiding unit 530.

The first and second light sources include a first LED 511 and a second LED 513, respectively. Alternatively, the first and second light sources may be a first fluorescent lamp and a second fluorescent lamp, respectively.

In FIG. 8, the backlight assembly 500 may further include a power supply unit 517. In a selective-state driving mode, the power supply unit 517 applies an electric current to the first and second LEDs 511 and 513. In a constant-state driving mode, the power supply unit 517 applies an electric current to the second LED 513, but does not apply an electric current to the first LED 511.

The first LED 511 generates a light in the selective-state driving mode, and does not generate the light in the constant-state driving mode. The second LED 513 may generate a light in both the selective-state driving mode and the constant-state driving mode. Alternatively, the second LED 513 may not generate the light in the selective-state driving mode.

The light guiding unit 530 guides the light generated from the first and second LEDs 511 and 513 toward a front of the backlight assembly 500. The light guiding unit 530 includes a light exiting surface 531, a first side surface 533, a second side surface 535 opposite to the first side surface 533, a third side surface 537 connecting the firs side surface 533 to the second side surface 535, and a fourth side surface 539 opposite to the third side surface 537. The first and second side surfaces 533 and 535 may be parallel to each other, and the third and fourth side surfaces 537 and 539 may be parallel to each other. The light exiting surface 531 includes a main region MS and a sub region SS. The main region MS and the sub region SS have a first area and a second area that is smaller than the first area, respectively. The main region MS is substantially parallel with the sub region SS in a first direction (x-direction). In other words, the main region MS may be substantially coplanar with the sub region SS.

The first side surface 533 is connected to the main region MS in the first direction. The second surface 535 corresponds to the first side surface 533, and connected to the sub region SS in the first direction. The third side surface 537 is connected to the main region MS and the sub region SS in a second direction (y-direction) that is substantially perpendicular to the first direction. The fourth side surface 539 corresponds to the third side surface 537, and is connected to the main region MS and the sub region SS in the second direction. The light guiding unit 530 may further include a corresponding surface (not shown) corresponding to the light exiting surface 531.

In FIG. 8, two first LEDs 511 are positioned on the first side surface 533. The second LED 513 is positioned on the third side surface 537 corresponding to the sub region SS. Alternatively, the number and location of the first and second LEDs 511 and 513 may be changed. For example, the first LED 511 may be on the third side surface 537 corresponding to the main region MS, and the second LED 513 may be on the second side surface 535.

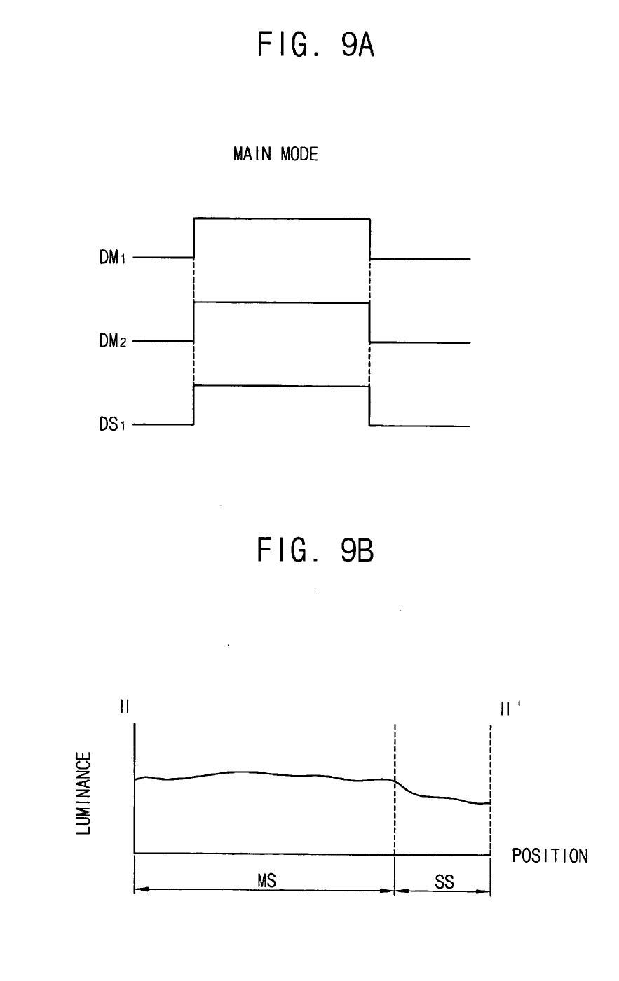

FIG. 9A is a timing diagram illustrating driving signals applied to a first and second diode of the exemplary backlight assembly of FIG. 8 in a selective-state driving mode. FIG. 9B is a graph illustrating a luminance of a light passing through an exemplary light guiding unit of the exemplary embodiment of the backlight assembly measured along line II-II′ of FIG. 8 in a selective-state driving mode.

Referring to FIGS. 8, 9A, and 9B, in the selective-state driving mode, each of the first LEDs DM1, DM2 (511 shown in FIG. 8) generates a light on the first side surface 533, and the second LED DS1 (513 shown in FIG. 8) generates a light on the third side surface 537 corresponding to a sub region SS. A light guiding unit 530 guides the light generated from the first and second LEDs DM1, DM2 and DS1 toward a front of the backlight assembly 500. The light guided by the light guiding unit 530 exits a main region MS and the sub region SS. The light exiting the main region MS has substantially the same luminance as the light exiting the sub region SS in the selective-state driving mode, thereby increasing a luminance uniformity of the backlight assembly 500.

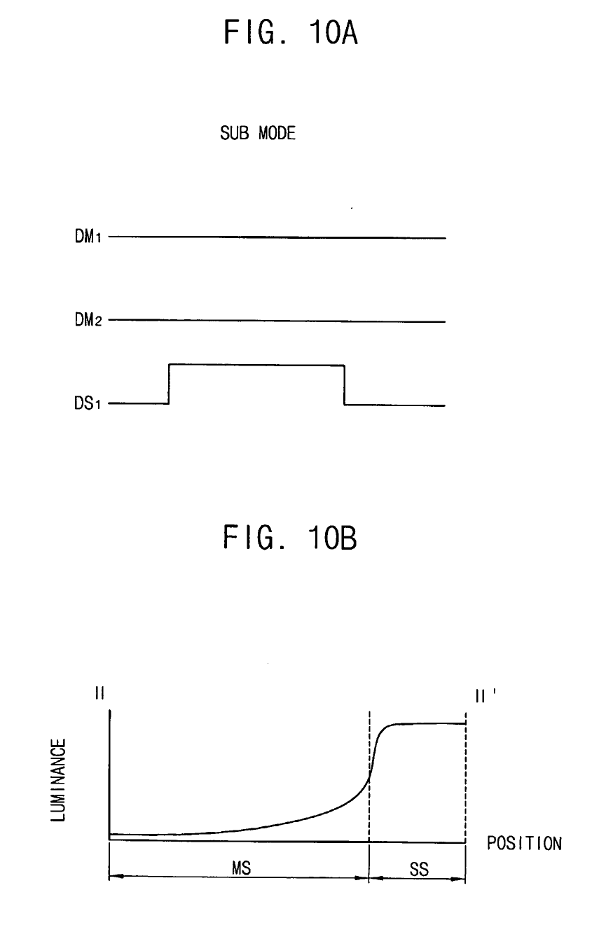

FIG. 10A is a timing diagram illustrating driving signals applied to a first and second diode of the exemplary embodiment of the backlight assembly of FIG. 8 in a constant-state driving mode. FIG. 10B is a graph illustrating a luminance of a light passing through a light guiding unit of the exemplary embodiment of the backlight assembly measured along line II-II′ of FIG. 8 in a constant-state driving mode.

Referring to FIGS. 8, 10A, and 10B, in the constant-state driving mode, the first LEDs DM1, DM2 (511 shown in FIG. 8) do not generate a light, and the second LED DS1 (513 shown in FIG. 8) only generates a light on the third side surface 537 corresponding to a sub region SS. A light guiding unit 530 guides the light generated from the second LED DS1 toward a front of the backlight assembly 500. In FIG. 10B, the light generated from the second LED DS1 guided toward a main region MS is negligible. The light guided by the light guiding unit 530 exits the sub region SS.

Therefore, substantially all of the light generated from the second LED DS1 is guided toward the sub region SS, a luminance of the sub region SS is increased although an electric current applied to the second LED DS1 (513 shown in FIG. 8) in the constant state mode is lower than an electric current applied to the second LED DS1 of the selective-state mode.

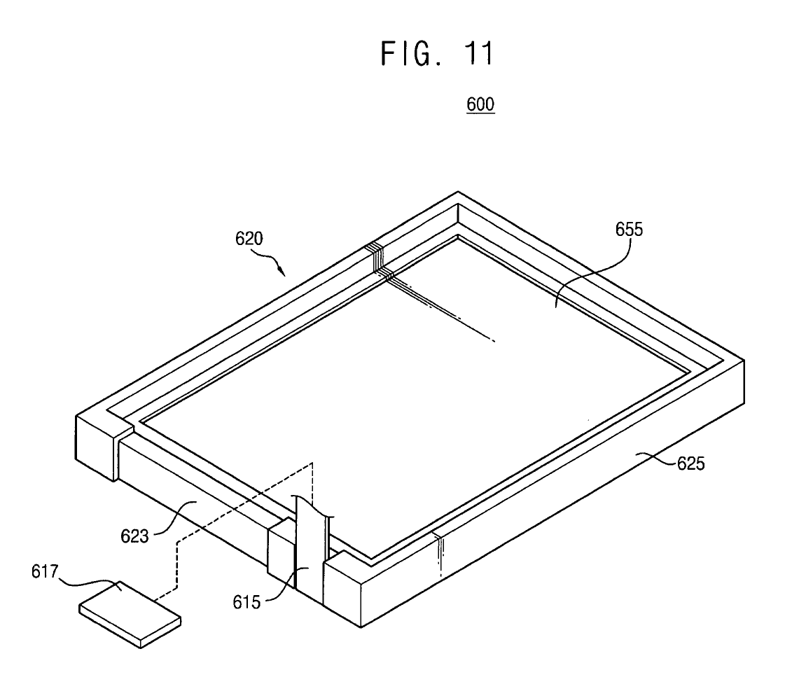

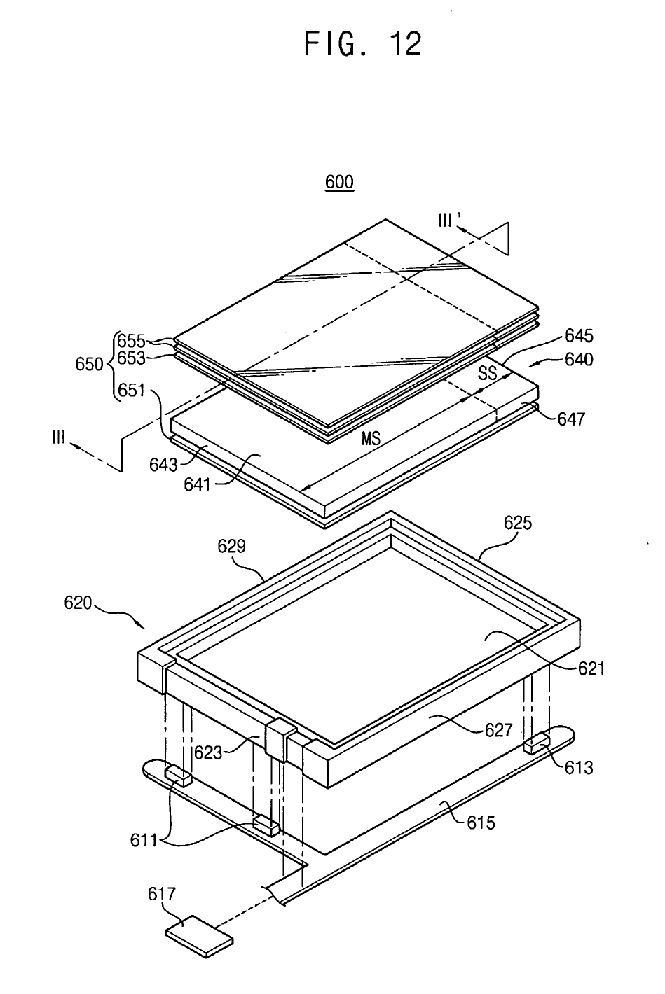

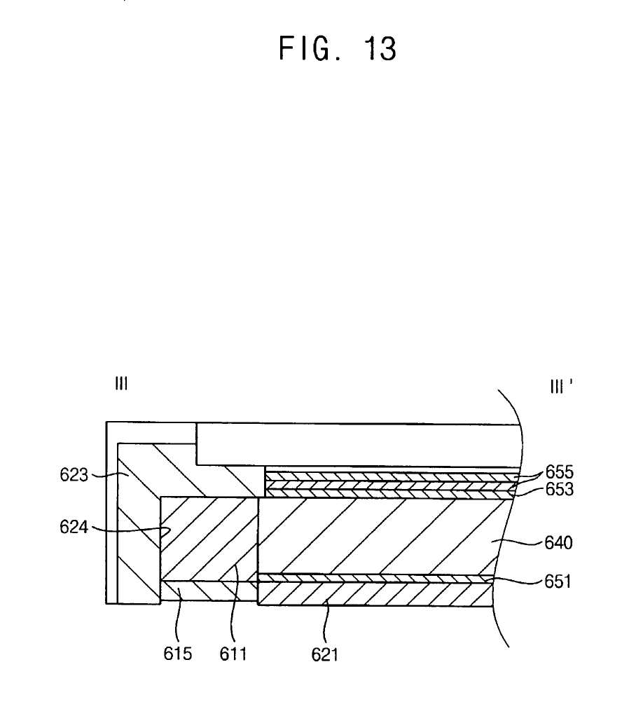

FIG. 11 is a perspective view illustrating an exemplary backlight assembly 600 in accordance with another exemplary embodiment of the present invention. FIG. 12 is an exploded perspective view illustrating the exemplary embodiment of the backlight assembly 600 shown in FIG. 11.

Referring to FIGS. 11 and 12, the backlight assembly 600 includes a first light source, a second light source, and a light guiding unit 640.

The first and second light sources include a first LED 611 and a second LED 613, respectively. The first and second light sources and the light guiding unit of FIGS. 11 and 12 are the same as in FIG. 8. Thus, any further explanation concerning the above elements will be omitted.

The backlight assembly 600 may further include a power supply printed circuit film 615, a power supply unit 617, and a receiving container 620.

The first and second LEDs 611 and 613 are electrically connected to the power supply unit 617 through the power supply printed circuit film 615. In FIGS. 11 and 12, the power supply printed circuit film 615 has an L-shape. The first LED 611 may be attached on a first portion of the power supply printed circuit film 615, and the second LED 613 may be attached to a second portion of the power supply printed circuit film 615, where the first and second portions may extend substantially perpendicular to each other to form the L-shape. A first power supply line and a second power supply line are electrically connected to the power supply printed circuit film 615. The first LED 611 is electrically connected to the first power supply line. The second LED 613 is electrically connected to the second power supply line.

The power supply unit of FIGS. 11 and 12 is the same as in FIG. 8. Thus, any further explanation concerning the power supply unit 617 will be omitted.

In a selective-state driving mode, the power supply unit 617 applies an electric current to the first LED 611 and the second LED 613. In a constant-state driving mode, the power supply unit 617 applies an electric current to the second LED 613, but not to the first LED 611.

FIG. 13 is a cross-sectional view taken along line III-III′ shown in FIG. 12.

Referring to FIGS. 11 to 13, the receiving container 620 includes a bottom plate 621, a first sidewall 623, a second sidewall 625, a third sidewall 627, and a fourth sidewall 629.

Although not illustrated, the bottom plate 621 may alternatively have an opening to decrease the weight of the backlight assembly 600. The first, second, third, and fourth sidewalls 623, 625, 627 and 629 are protruded from sides of the bottom plate 621. The first sidewall 623 is opposite to and corresponds to the second sidewall 625, and may be parallel to each other. The third sidewall 627 is opposite to and corresponds to the fourth sidewall 629, and may be parallel to each other. Each of the third and fourth sidewalls 627 and 629 is connected between the first and second sidewalls 623 and 625.

Referring again to FIG. 13, three first recesses 624 are formed on the first sidewall 623, and three holes are formed through a peripheral portion of the bottom plate 621 corresponding to the first recesses 624. While three recess 624 and corresponding holes are described, an alternate number may be provided for an alternate number of LEDs. A second hole (not shown) is formed on the third sidewall 625, and a hole is formed through a peripheral portion of the bottom plate 621 corresponding to the second hole (not shown).

The first LEDs 611 are inserted into each of the first recesses 624 through the holes of the bottom plate 621. The second LED 613 is inserted into the second recess (not shown) through the hole of the bottom plate 621.

A first guiding recess and a second guiding recess are formed on the first sidewall 623 along an outer surface of the first sidewall 623. A portion of the power supply printed circuit film 615 is received in the guiding recesses as shown in FIG. 11 so that the power supply printed circuit film 615 is bent and electrically connected to the power supply unit 617.

The light guiding unit 640 guides the light generated from the first and second LEDs 611 and 613 and into the first side surface 643, a first light incident surface, towards a front of the backlight assembly 600. In the selective-state driving mode, the light guiding unit 640 guides the light generated from the first and second LEDs 611 and 613 toward a main display part and a sub display part of a display panel (not shown). In the constant-state driving mode, the light guiding unit 640 guides the light generated from the second LED 613 and incident into the third side surface 647, which is a second light incident surface, toward the sub display part of the display panel (not shown). The second side surface 645 of the light guiding unit 640 is opposite the first side surface 643 and is adjacent the second sidewall 625 of the receiving container 620 when the light guiding unit 640 is received therein.

The backlight assembly 600 may further include optical sheets 650.

The optical sheets 650 improve optical characteristics of the light exiting the light guiding unit 640. The optical sheets 650 cover the main region MS and the sub region SS of the light guiding unit 640.

The optical sheets 650 include a reflecting sheet 651, a diffusion sheet 653 and a plurality of brightness enhancement sheets 655.

The reflecting sheet 651 is on the corresponding surface (not shown) of the light guiding unit 640, opposite the light exiting surface 641, so that a portion of the light leaked from the light guiding unit 640 through the corresponding surface is reflected from the reflecting sheet 651 back toward the light guiding unit 640, thereby increasing the luminance of the backlight assembly 600.

The diffusion sheet 653 and the brightness enhancement sheets 655 are on the light exiting surface 641. The diffusion sheet 653 diffuses the light exiting the light guiding unit 640 to increase a luminance uniformity of the light. In FIG. 13, longitudinal directions of the brightness enhancement sheets 655 are different from each other to increase the luminance when viewed on a plane.

The reflecting sheet 651, the light guiding unit 640, the diffusion sheet 653 and the brightness enhancement sheets 655 are received on the bottom plate 621 of the receiving container 620, in sequence. The first 643, second 645, third 647, and fourth (not shown) side surfaces of the light guiding unit 640 correspond to the first, second, third and fourth sidewalls 623, 625, 627 and 629 of the receiving container 620, respectively. The first LED 611 generates the light on the first side surface 643 of the light guiding unit 640. The second LED 613 generates the light on the third side surface 647 of the light guiding unit 640 corresponding to the sub region SS.

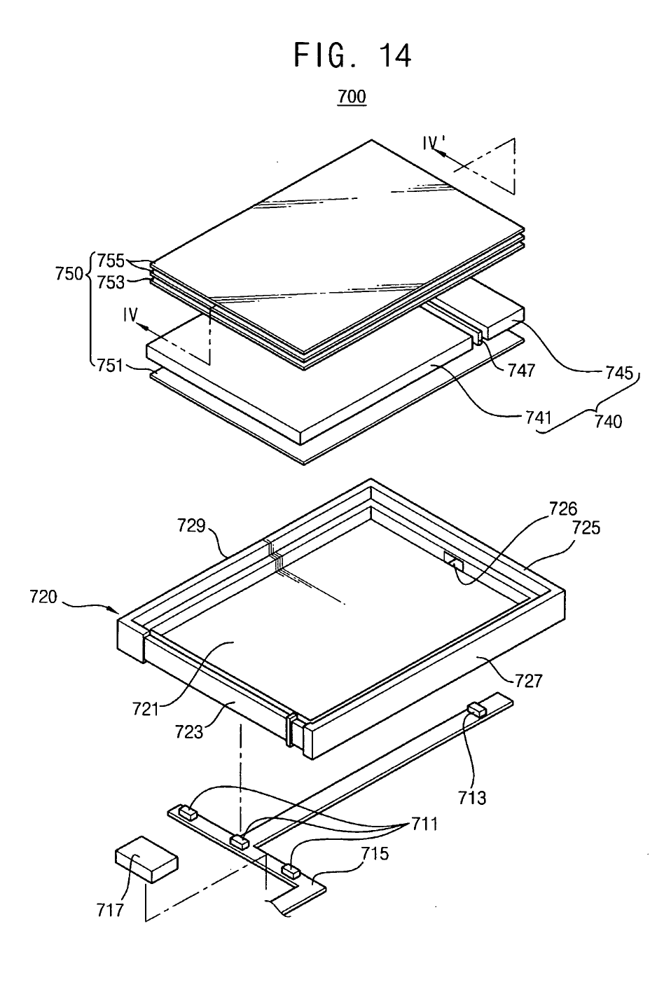

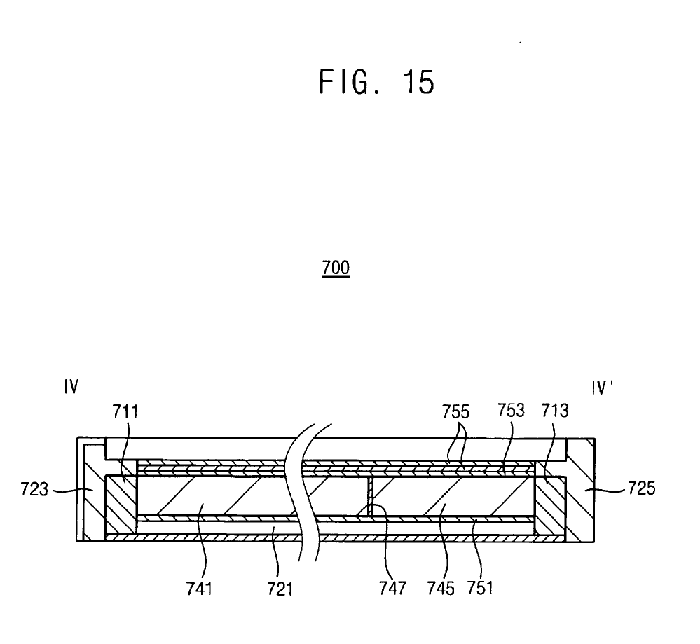

FIG. 14 is an exploded perspective view illustrating an exemplary backlight assembly 700 in accordance with another exemplary embodiment of the present invention. FIG. 15 is a cross-sectional view taken along line IV-IV′ shown in FIG. 14.

Referring to FIGS. 14 and 15, the backlight assembly 700 includes a first light source, a second light source, a power supply printed circuit film 715, a power supply unit 717, a receiving container 720, a light guiding unit 740, and optical sheets 750.

In FIGS. 14 and 15, the first and second light sources include a first LED 711 and a second LED 713. The first and second light sources of FIGS. 14 and 15 are the same as in FIG. 12 except for a driving method. Thus, any further explanation concerning the first and second light sources will be omitted.

The first LED 711 generates a light in a selective-state driving mode, and does not generate the light in a constant-state driving mode. The second LED 713 does not generate a light in the selective-state driving mode, and generates the light in the constant-state driving mode. The power supply unit 717 applies an electric current to the first LED 711 in the selective-state driving mode, and the electric current to the second LED 713 in the constant-state driving mode.

For example, the power supply printed circuit film 715 may have a substantially T-shaped arrangement. For example, a first portion of the power supply printed circuit film 715 may extend in a first direction and receive the first LEDs 711 thereon, and a second portion of the power supply printed circuit film 715 may extend in a second direction, substantially perpendicular to the first direction, from a central area of the first portion and may receive the second LED 713 thereon. The power supply printed circuit film 715 includes first and second conductive lines that are electrically connected to the first and second LEDs 711 and 713, respectively. For example, three first LEDs 711 are mounted on the first portion of the T-shape of the power supply printed circuit film 715. In addition, the second LED 713 is mounted on the second portion of the T-shape of the power supply printed circuit film 715.

The receiving container 720 of FIGS. 14 and 15 is substantially the same as in FIG. 12 except for a second recess 726. Thus, any further explanation concerning the same elements of the receiving container 720 will be omitted. The second recess 726 is formed on an inner surface of a second sidewall 725 to receive the second LED 713. The second sidewall 725 is opposite to the first sidewall 723, and the third and fourth sidewalls 727, 729 are opposite to each other and connect the first sidewall 723 to the second sidewall 725.

The light guiding unit 740 includes a main light guiding plate 741 and a sub light guiding plate 745 separate from the main light guiding plate 741.

The light guiding unit 740 of FIGS. 14 and 15 is substantially the same as in FIG. 12 except that the light guiding unit 740 is divided into the main and sub light guiding plates 741 and 745. Thus, any further explanation concerning the same features of the light guiding unit 740 will be omitted. A light exiting surface of the main light guiding plate 741 has a first area, and a light exiting surface of the sub light guiding plate 745 has a second area that is smaller than the first area.

In the selective-state driving mode, the main light guiding plate 741 guides the light generated from the first LEDs 711 toward the front of the backlight assembly 700. In the constant-state driving mode, the sub-light guiding plate 745 guides the light generated from the second LED 713 toward the front of the backlight assembly 700.

The light guiding unit 740 may further include a light reflecting layer 747. The light reflecting layer 747 is interposed between the main light guiding plate 741 and the sub light guiding plate 745 to optically separate the main light guiding plate 741 from the sub light guiding plate 745. The reflecting layer 747 may have a substantially plate-shaped form extending at a non-zero angle, such as substantially perpendicularly, to the light exiting surface of the light guiding unit 740. The reflecting layer 747 includes a highly reflective material. Examples of the highly reflective material that can be used for the reflecting layer 747 include aluminum, aluminum-neodymium alloy, silver, etc.

The optical sheets 750 shown in FIGS. 14 and 15 are the same as in FIGS. 11 to 13. Thus, any further explanation concerning the optical sheets will be omitted.

The reflecting sheet 751, the light guiding unit 740, the diffusion sheet 753 and the brightness enhancement sheets 755 are received on the bottom plate 721 of the receiving container 720, in sequence. The main light guiding plate 741 is substantially parallel with the sub light guiding plate 745. The reflecting layer 747 is interposed between the main and sub light guiding plates 741 and 745.

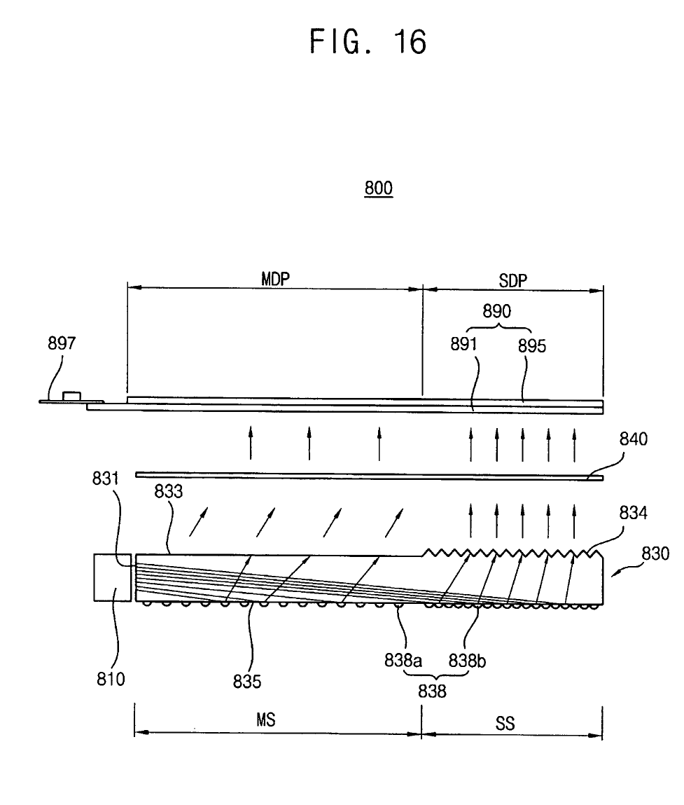

FIG. 16 is a cross-sectional view illustrating an exemplary display device 800 in accordance with another exemplary embodiment of the present invention.

Referring to FIG. 16, the display device 800 includes a light source, a light guiding unit 830, and a display panel 890. In FIG. 16, the light source may include an LED 810, although other light sources are within the scope of these embodiments.

The LED 810 and the light guiding unit 830 shown in FIG. 16 are the same as the light source 131 and the light guiding unit 139 shown in FIG. 2. Thus, any further explanation concerning the above elements will be omitted.

Refractive indexes of the light guiding unit 830 and air are 1.49 and 1.0, respectively. Light from the LED 810 enters the light guiding unit 830 through the light incident surface 831. An exiting angle of a light exiting a main region MS of a light exiting surface 833 of the light guiding unit 830 forms an angle of about 75° to about 83° with respect to a normal direction that is substantially perpendicular to the light exiting surface 833 of the light guiding unit 830. An optical pattern 834 formed in the sub region SS of the light exiting surface 833 of the light guiding unit 830 guides a light exiting the sub region SS of the light exiting surface 833 of the light guiding unit 830 toward the display device 800.

A light scattering pattern 838 is formed on a corresponding surface 835 of the light guiding unit 830. The light scattering pattern 838 has a plurality of dot shapes. The light scattering pattern 838a of the main region MS may have a lower density than the light scattering pattern 838b of the sub region SS. Therefore, a loss of the light in the sub region SS is compensated by the light scattering pattern 838 to increase a luminance uniformity of the display device 800.

The display device 800 may further include optical sheets 840. The optical sheets 840 may be the same as or variations of the optical sheets of the prior embodiments. The optical sheets 840 improve optical characteristics such as the luminance uniformity, the luminance when viewed on a plane, etc., of the light exiting the light exiting surface 833 of the light guiding unit 830. For example, the light exiting the light exiting surface 833 may be a uniform light.

The display panel 890 displays an image using the uniform light exiting the light guiding unit 830. The display panel 890 includes a main display part MDP and a sub display part SDP. In a selective-state driving mode, the image is displayed on the main and sub display parts MDP and SDP. In a constant-state driving mode, the image is only displayed on the sub display part SDP, and the image is not displayed on the main display part MDP.

The main display part MDP selectively displays a main image based on the light exiting the main region MS of the light guiding unit 830. The sub display part SDP constantly displays a sub image based on the light exiting the sub region SS in which the optical pattern 834 is formed.

The display panel 890 includes a first substrate 891, a second substrate 895, and a liquid crystal layer (not shown) sandwiched between the first and second substrates 891, 895.

The first substrate 891 includes a main pixel part and a sub pixel part. In the selective-state driving mode, a first driving signal is applied to a pixel electrode, or pixel electrodes, on the main pixel part to display the main image. In the selective-state driving mode and the constant-state driving mode, a second driving signal is applied to a pixel electrode, or pixel electrodes, on the sub pixel part to display the sub image.

The second substrate 895 corresponds to the first substrate 891. The second substrate 895 includes a main color filter part and a sub color filter part. The main color filter part of the second substrate 895 corresponds to the main pixel part of the first substrate 891. The main color filter part and the main pixel part form the main display part MDP. The sub color filter part of the second substrate 895 corresponds to the sub pixel part of the first substrate 891. The sub color filter part and the sub pixel part form the sub display part SDP. The second substrate 895 may further include a common electrode corresponding to the pixel electrodes of the first substrate 891.

The liquid crystal layer (not shown) is interposed between the first and second substrates 891 and 895.

The display panel 890 may further include a panel printed circuit film 897. The panel printed circuit film 897 is electrically connected to an end portion of the first substrate 891 to transmit a panel driving signal to the display panel 890.

An electric field is formed between each of the pixel electrodes on the first substrate 891 and the common electrode on the second substrate 895 based on the panel driving signal. Liquid crystals of the liquid crystal layer (not shown) vary in arrangement in response to the electric field applied thereto, and thus a light transmittance of the liquid crystal layer (not shown) is changed, thereby displaying the main image or the sub image.

In the selective-state driving mode, a first electric current is applied to the LED 810 to display the main image and the sub image on the main display part MDP and the sub display part SDP, respectively, of the display panel 890.

In the constant-state driving mode, a second electric current that is smaller than the first electric current is applied to the LED 810 so that the optical pattern 834 and the light scattering pattern 838 of the light guiding unit 830 guide the light toward the sub region SS of the light guiding unit 830 to display the sub image on the sub display part SDP of the display panel 890. Therefore, the luminance of the sub image is increased, although the second electric current is smaller than the first electric current.

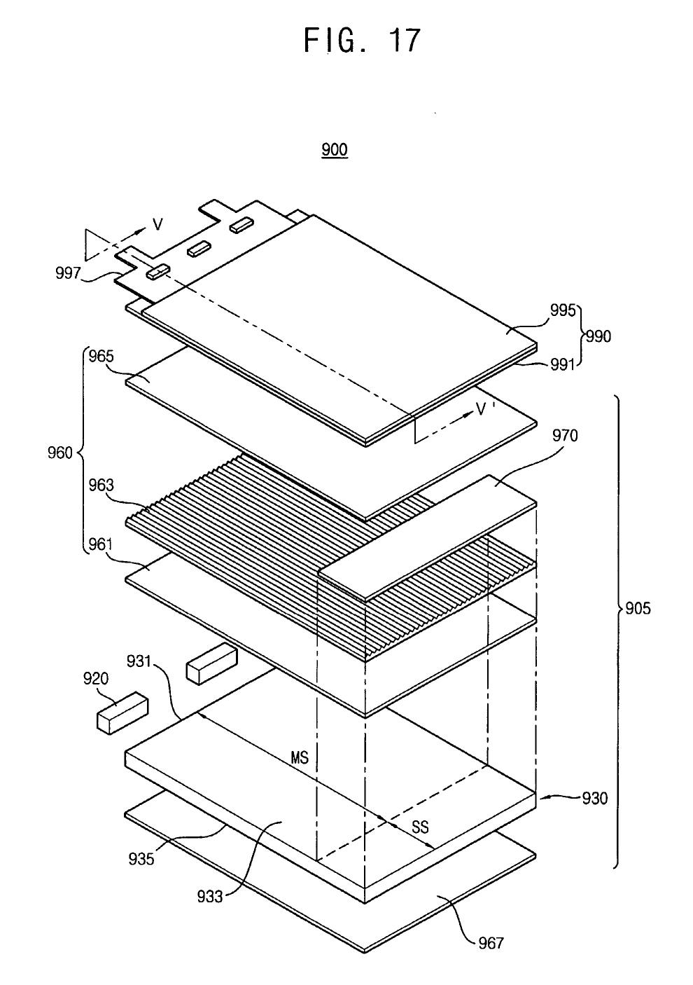

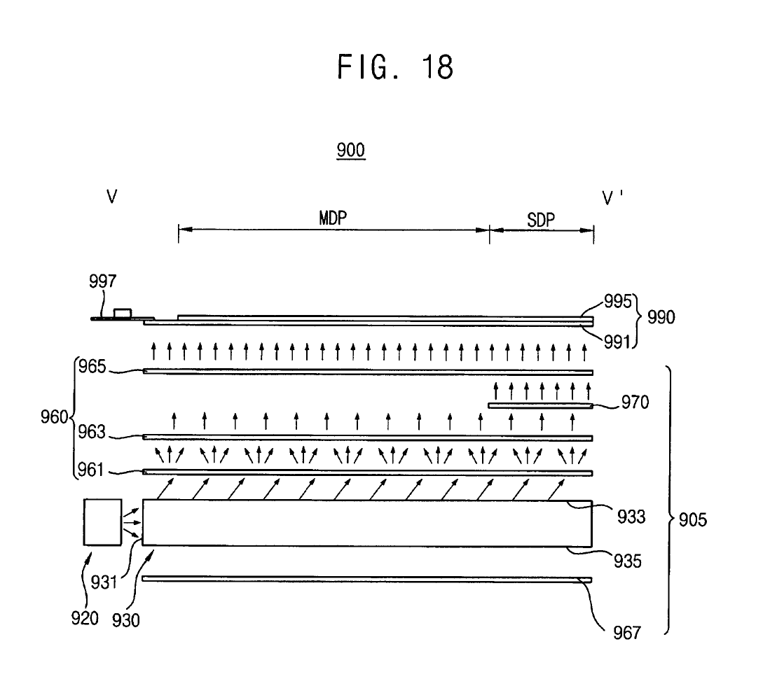

FIG. 17 is an exploded perspective view illustrating an exemplary display device 900 in accordance with another exemplary embodiment of the present invention. FIG. 18 is a cross-sectional view taken along line V-V′ shown in FIG. 17.

Referring to FIGS. 17 and 18, the display device 900 includes a light source, a light guiding unit 930, a first optical sheet 960, a second optical sheet 970, and a display panel 990. In FIGS. 17 and 18, the light source may include an LED 920, although other light sources would be within the scope of these embodiments. Light from the LED 920 is incident on the light incident surface 931 of the light guiding unit 930 and the light either exits a light exiting surface 933 or reflects between the light exiting surface 933 and a corresponding surface 935 before exiting the light exiting surface 933.

The backlight assembly 905 including the LED 920, the light guiding unit 930, and the first and second optical sheets 960 and 970 shown in FIGS. 17 and 18 are the same as the light source 310, the light guiding unit 330, and the first and second optical sheets 360 and 370 in FIG. 5. Thus, any further explanation concerning the above elements will be omitted.

The display panel 990 having the first and second substrates 991, 995 and the panel printed circuit film 997 attached to the first substrate 991 as shown in FIGS. 17 and 18 are the same as in FIG. 16. Thus, any further explanation concerning the above elements will be omitted.

The display panel 990 includes a main display part MDP and a sub display part SDP. The main display part MDP corresponds to a main region MS of the light guiding unit 930, and the sub display part SDP corresponds to a sub region SS of the light guiding unit 930. The display panel 990 displays an image based on a light exiting the first and second optical sheets 960 and 970. The first optical sheets 960 include a diffusion sheet 961, a brightness enhancement sheet 963, and a protecting sheet 965 disposed on the light guiding unit 930. A reflecting sheet 967 may further be provided on the corresponding surface 935 of the light guiding unit 930. The second optical sheet 970 is disposed between the brightness enhancement sheet 963 and the protecting sheet 965 of the first optical sheets 960.

The main display part MDP displays a main image based on the light exiting the first optical sheet 960. For example, the main image includes an image, a character, etc.

The sub display part SDP displays a sub image based on the light exiting the first and second optical sheet 960 and 970 in the selective-state driving mode and a constant-state driving mode. For example, the sub image includes time, date, battery state, etc.

The LED 920 of the constant-state driving mode receives a smaller electric current than the LED 920 of the selective-state driving mode so that a luminance of the LED 920 of the constant-state driving mode is smaller than that of the selective-state driving mode. However, the second optical sheet 970 increases the luminance of the light in a sub region SS of the light guiding unit 930. That is, the luminance of the light exiting the sub region SS in the constant-state driving mode is increased, although the LED 920 of the constant-state driving mode receives a smaller electric current than the LED 920 of the selective-state driving mode.

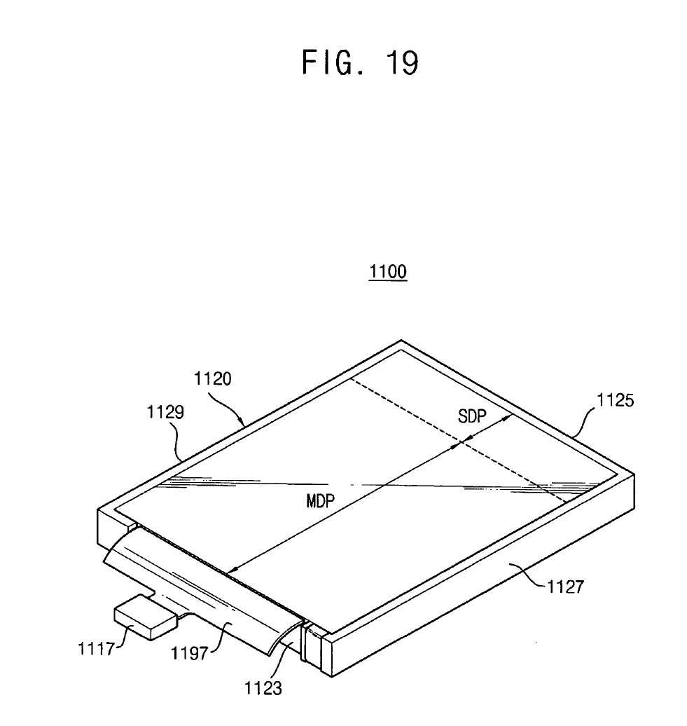

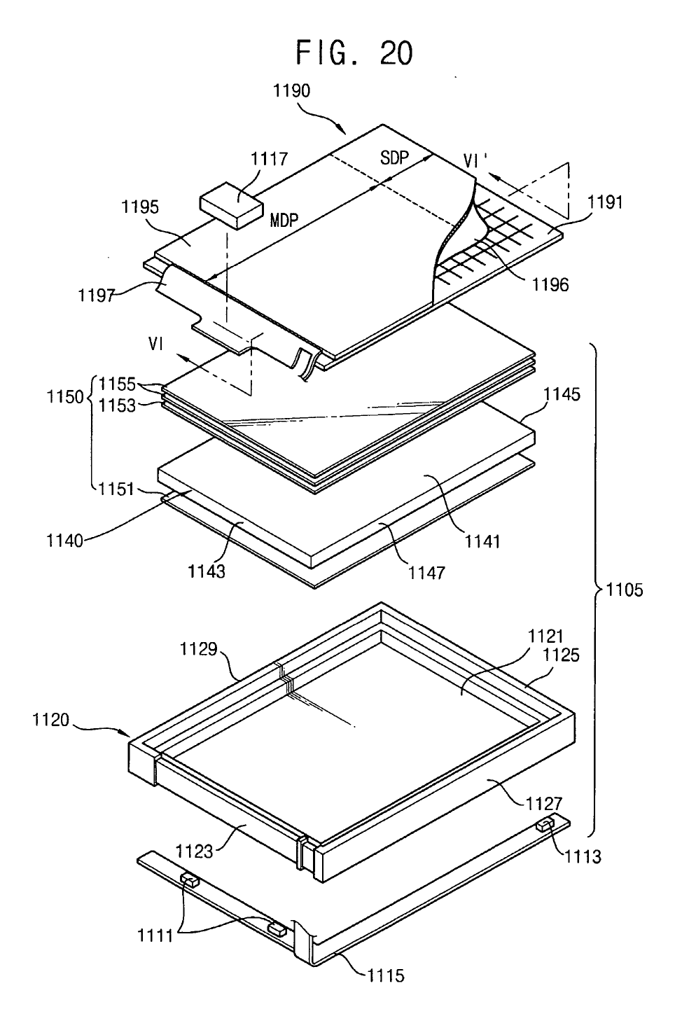

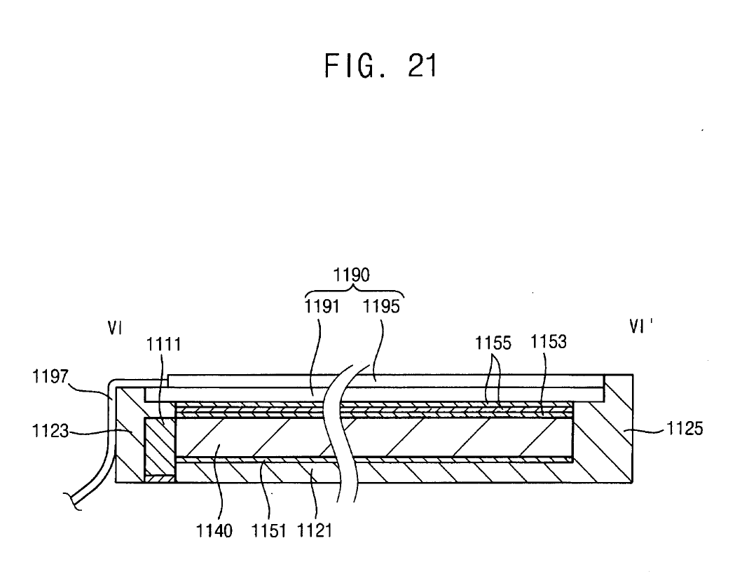

FIG. 19 is a perspective view illustrating an exemplary display device 1100 in accordance with another exemplary embodiment of the present invention. FIG. 20 is an exploded perspective view illustrating the exemplary embodiment of the display device shown in FIG. 19. FIG. 21 is a cross-sectional view taken along line VI-VI′ shown in FIG. 20.

Referring to FIGS. 19 to 21, the display device 1100 includes a backlight assembly 1105, a driving circuit part 1117, and a display panel 1190.

The backlight assembly 1105 includes a first light source, a second light source, a power supply printed circuit film 1115, a receiving container 1120, a light guiding unit 1140, and optical sheets 1150. The first and second light-emitting sources may include a first LED 1111 and a second LED 1113, respectively. The receiving container 1120 includes a bottom plate 1121, a first sidewall 1123, a second sidewall 1125, a third sidewall 1127, and a fourth sidewall 1129. A reflecting sheet 1151, a part of the optical sheets 1150, is disposed on the bottom plate 1121. The light guiding unit 1140 includes a first surface 1143, an opposite second surface 1145, a third surface 1147, and a fourth surface that are disposed adjacent to the first sidewall 1123, the second sidewall 1125, the third sidewall 1127, and the fourth sidewall 1129, respectively. The optical sheets 1150 further include a diffusion sheet 1153 and brightness enhancement sheets 1155. Light exiting the light guiding unit 1140 through the light exiting surface 1141 passes through the diffusion sheet 1153 and the brightness enhancement sheets 1155 prior to its incidence on the display panel 1190. The backlight assembly 1105 shown in FIGS. 19 and 21 is substantially the same as in FIGS. 11 to 13 except for the power supply unit 617 of the backlight assembly 600. Thus, any further explanation concerning the above elements will be omitted.

The driving circuit part 1117 applies an electric current to the first and second LEDs 1111 and 1113 in a selective-state driving mode, and applies an electric current to the second LED 1113 in a constant-state driving mode. The driving circuit part 1117 is electrically connected to the power supply printed circuit film 1115 through a panel printed circuit film 1197.

The display panel 1190, having the first and second substrates 1191 and 1195 with the liquid crystal layer 1196 there between, as shown in FIGS. 19 and 21 are the same as in FIG. 17 except for a power supply unit. Thus, any further explanation concerning the above elements will be omitted. The driving circuit part 1117 is mounted on the panel printed circuit film 1197 to drive the display device. The driving circuit 1117 outputs driving signals for driving the display panel 1190 and the electric current for driving the first and second LEDs 1111 and 1113. The driving signals include a data signal, a control signal, etc.

A first sidewall 1123 of the receiving container 1120 has a first guide groove and a second guide groove. The panel printed circuit film 1197 is received in the first and second guide grooves. The panel printed circuit film 1197 is electrically connected to the power supply printed circuit film 1115 in the second guide groove of the first sidewall 1123. The panel printed circuit film 1197 is bent and received in the first guide groove along the first sidewall 1123 as shown in FIG. 21.

The display panel 1190 displays an image based on a light generated from the backlight assembly 1105.

In the selective-state driving mode, the first and second LEDs 1111 and 1113 of the backlight assembly 1105 generate a light based on a control signal of the driving circuit part 1117 to supply the main display part MDP and the sub display part SDP with the light. The display panel 1190 displays a main image on the main display part MDP based on the control signal of the driving circuit part 1117. The main image includes an image, a character, etc. The display panel 1190 displays a sub image on the sub display part SDP based on the control signal of the driving circuit part 1117. The sub image includes time, date, battery state, etc. Alternatively, the second LED 1113 may not generate the light in the selective-state driving mode.

In the constant-state driving mode, the second LED 1113 generates the light based on the control signal of the driving circuit part 1117 to supply the sub display part SDP with the light generated from the second LED 1113. The display panel 1190 displays the sub image on the sub display part SDP based on the control signal of the driving circuit part 1117. The sub image includes time, date, battery state, etc. In the constant-state driving mode, the first LEDs 1111 may not generate a light.

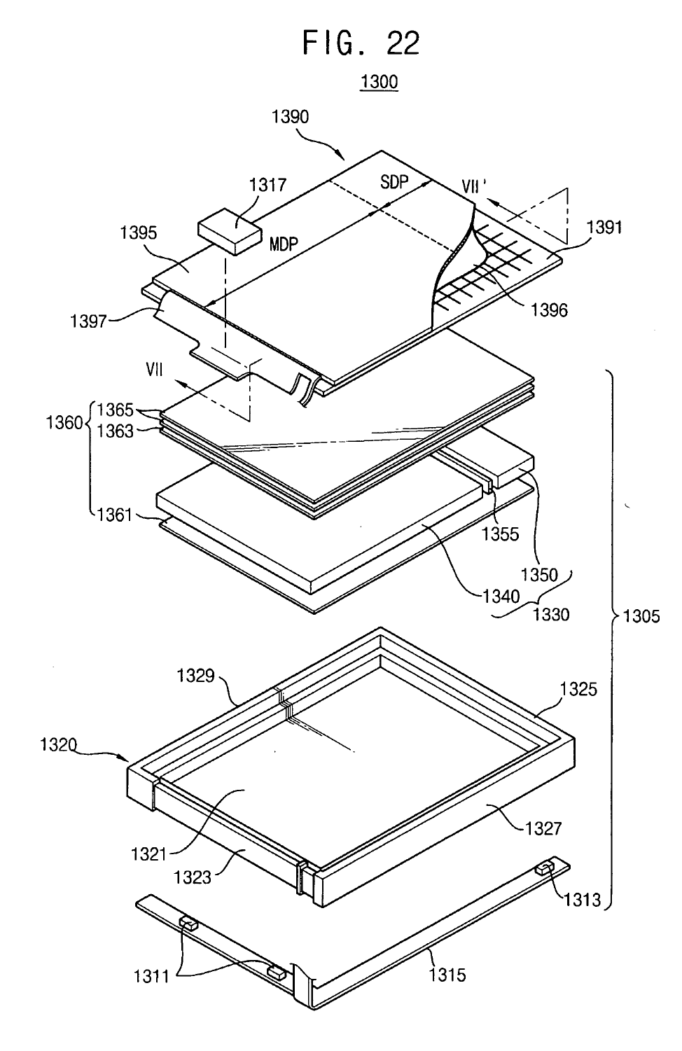

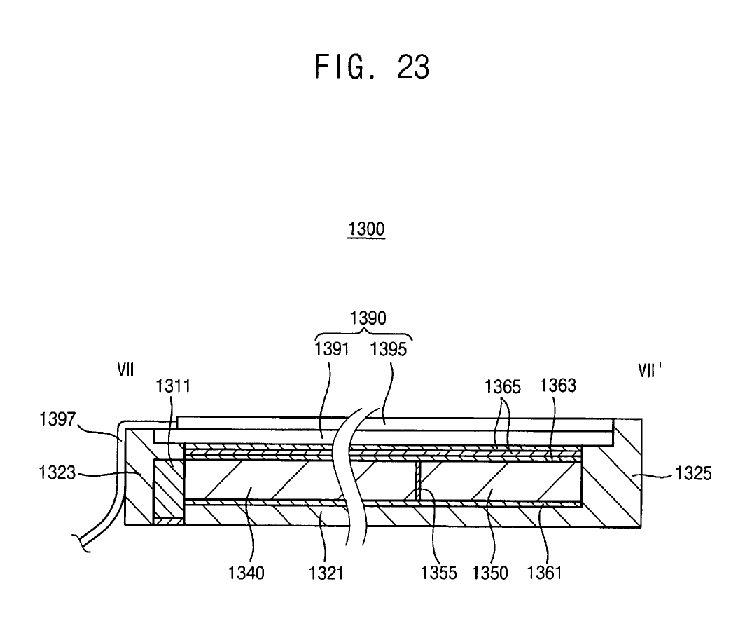

FIG. 22 is an exploded perspective view illustrating an exemplary display device 1300 in accordance with another exemplary embodiment of the present invention. FIG. 23 is a cross-sectional view taken along line VII-VII′ shown in FIG. 22.

Referring to FIGS. 22 and 23, the display device 1300 includes a backlight assembly 1305, a driving circuit part 1317, and a display panel 1390.

The backlight assembly 1305 includes a first light source, a second light source, a power supply printed circuit film 1315, a receiving container 1320, a light guiding unit 1330, and an optical sheet 1360. The first and second light sources include a first LED 1311 and a second LED 1313, respectively. The receiving container 1320 includes a bottom plate 1321, a first sidewall 1323, a second sidewall 1325, a third sidewall 1327, and a fourth sidewall 1329. A reflecting sheet 1361 of the optical sheets 1360 is received on the bottom plate 1321. The light guiding unit 1330, including the main light guide plate 1340, the sub light guide plate 1350, and the interposing reflecting layer 1355, is provided on the reflecting sheet 1361. The optical sheets 1360 further include a diffusion sheet 1363 and brightness enhancement sheets 1365. The backlight assembly 1305 shown in FIGS. 22 and 23 is substantially the same as the backlight assembly 700 as shown in FIG. 14 except for a power supply unit, the first and second light sources, the power supply printed circuit film, and the receiving container. The first and second light sources, the power supply printed circuit film 1315 and the receiving container 1320 shown in FIGS. 22 and 23 are the same as in FIG. 12. Thus, any further explanation concerning the above elements will be omitted.

The display panel 1390 includes a first substrate 1391, a second substrate 1395, and a liquid crystal layer 1396 disposed there between. The driving circuit part 1317 is connected to the panel printed circuit film 1397 connected to the first substrate 1391. The driving circuit part 1317 and the display panel 1390 shown in FIGS. 22 and 23 are the same as in FIG. 20. Thus, any further explanation concerning the above elements will be omitted.

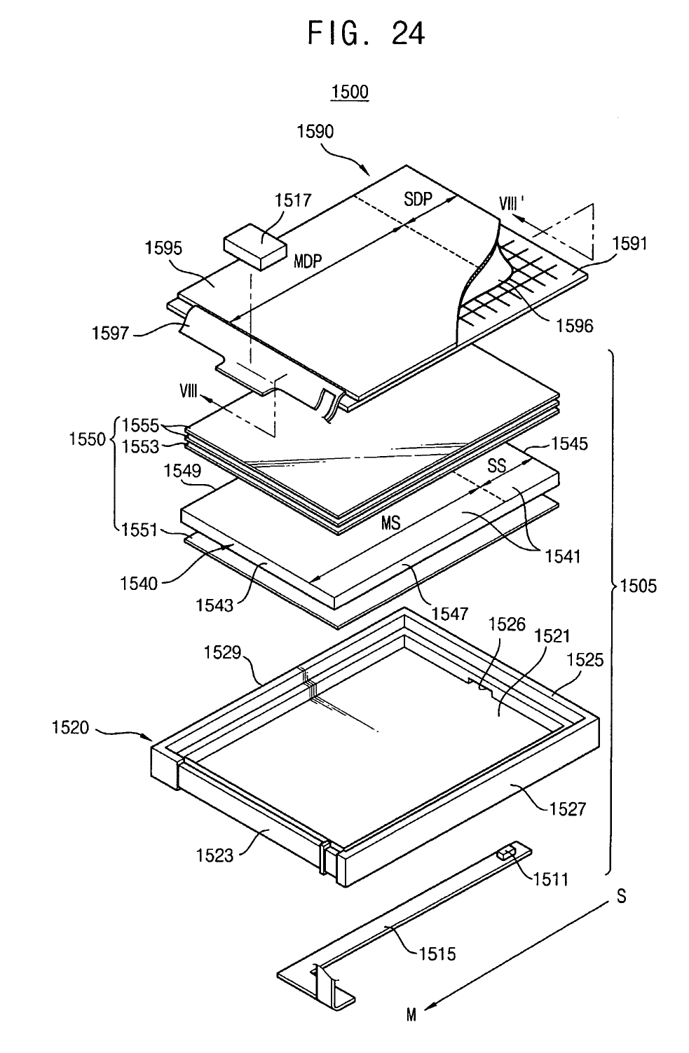

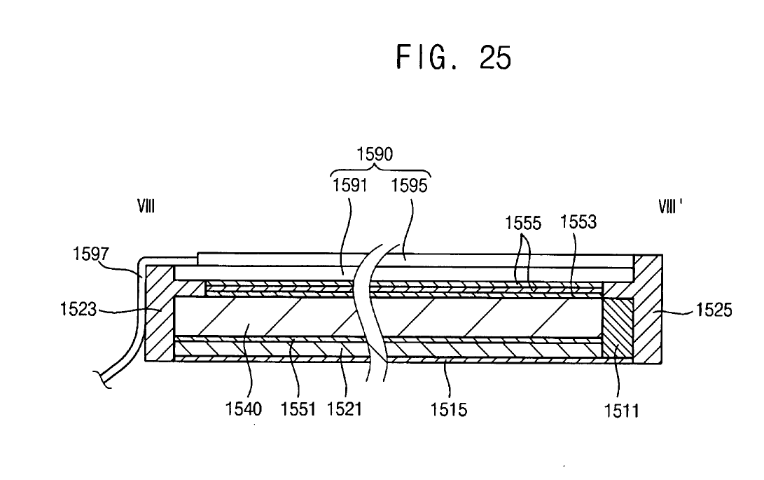

FIG. 24 is an exploded perspective view illustrating an exemplary display device 1500 in accordance with another exemplary embodiment of the present invention. FIG. 25 is a cross-sectional view taken along line VIII-VIII′ shown in FIG. 24.

Referring to FIGS. 24 and 25, the display device 1500 includes a backlight assembly 1505, a driving circuit part 1517, and a display panel 1590.

The backlight assembly 1505 includes a point light source, a power supply printed circuit film 1515, a receiving container 1520, a light guiding unit 1540, and an optical sheet 1550. The receiving container 1520 includes a bottom plate 1521, a first sidewall 1523, a second sidewall 1525, a third sidewall 1527, and a fourth sidewall 1529. A reflecting sheet 1551 of the optical sheet 1550 is provided on the bottom plate 1521 of the receiving container 1520. The optical sheet 1550 also includes a diffusion sheet 1553 and brightness enhancement sheets 1555 disposed between the light guiding unit 1540 and the display panel 1590. The backlight assembly 1505 shown in FIGS. 24 and 25 is substantially the same as in FIGS. 11 to 13 except for the point light source, the power supply printed circuit film, a receiving container and a power supply unit. Thus, any further explanation concerning the above elements will be omitted.

In FIGS. 24 and 25, the point light source of the backlight assembly 1505 includes an LED 1511. For example, the number of the LED 1511 is one to decrease power consumption and manufacturing costs.

The light guiding unit 1540 includes a light exiting surface 1541, a first side surface 1543, a second side surface 1545, a third side surface 1547 and a fourth side surface 1549. The light exiting surface 1541 includes a main region MS and a sub region SS. The main region MS and the sub region SS are connected to each other in a first direction (S-M direction). The first side surface 1543 is connected to the main region MS in the first direction. The second side surface 1545 corresponds to the first side surface 1543, and connected to the sub region SS. The third surface 1547 is connected to the main region MS and the sub region SS in a direction substantially perpendicular to the first direction. The fourth side surface 1549 corresponds to the third side surface 1547, and is connected to the main and sub regions MS and SS. The first through fourth side surfaces 1543, 1545, 1547,1549 of the light guiding unit 1540 correspond to the first through fourth sidewalls 1523, 1525, 1527, 1529 of the receiving container 1520. The light guiding unit 1540 may further include a corresponding surface corresponding to the light exiting surface 1541 and adjacent the reflecting sheet 1551. The LED 1511 is on the second side surface 1545 of the light guiding unit 1540, and may be disposed within a recess 1526 in the second sidewall 1525 of the receiving container 1520.

The display panel 1590 includes a first substrate 1591, a second substrate 1595, and a liquid crystal layer 1596 disposed between the first and second substrates 1591, 1595. A panel printed circuit film 1597 is connected to the first substrate 1591, and the driving circuit part 1517 is connected to the panel printed circuit film 1597. The driving circuit part 1517 and the display panel 1590 shown in FIGS. 24 and 25 are the same as in FIGS. 19 to 21. Thus, any further explanation concerning the above elements will be omitted.

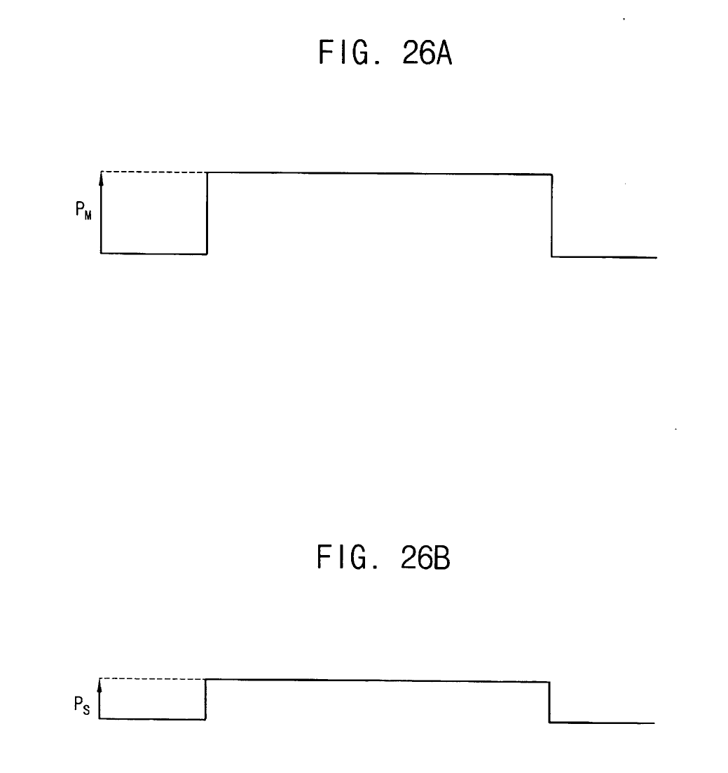

FIGS. 26A and 26B are graphs illustrating a relationship between driving signals applied to LEDs and power consumption. FIG. 26A is a graph illustrating a first electric current signal of the selective-state driving mode applied to the LED 1511 shown in FIGS. 24 and 25. FIG. 26B is a graph illustrating a second electric current signal of the constant-state driving mode applied to the LED 1511 shown in FIGS. 24 and 25.

Referring to FIGS. 24 to 26B, the driving circuit part 1517 applies a first electric current to the LED 1511 in the selective-state driving mode, and applies a second electric current that is smaller than the first electric current to the LED 1511 in the constant-state driving mode. In the constant-state driving mode, the main display part MDP does not display any image.

In FIG. 26A, a height Pm of the first electric current corresponds to a level of the first electric current applied to the LED 1511 in the selective-state driving mode. In FIG. 26B, a height Ps of the second electric current corresponds to a level of the second electric current applied to the LED 1511 in the constant-state driving mode. That is, in the constant-state driving mode for displaying the sub image on the sub display part SDP, the second electric current that is smaller than the first electric current is applied to the LED 1511, thereby decreasing power consumption of the backlight assembly 1505.

The sub display part SDP constantly displays the sub image. In addition, when an image display quality of the sub display part SDP is increased, an image display quality of the display device 1500 is also increased. For example, the LED 1511 may be on the second side surface 1545 connected to the sub region SS of the light-emitting surface 1541 to increase a luminance of the sub display part SDP.

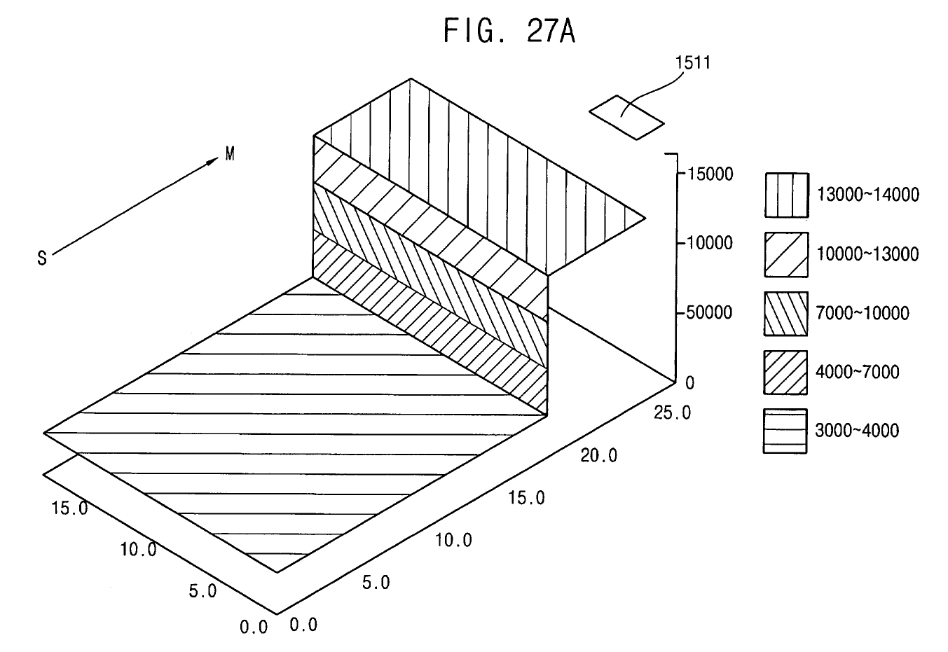

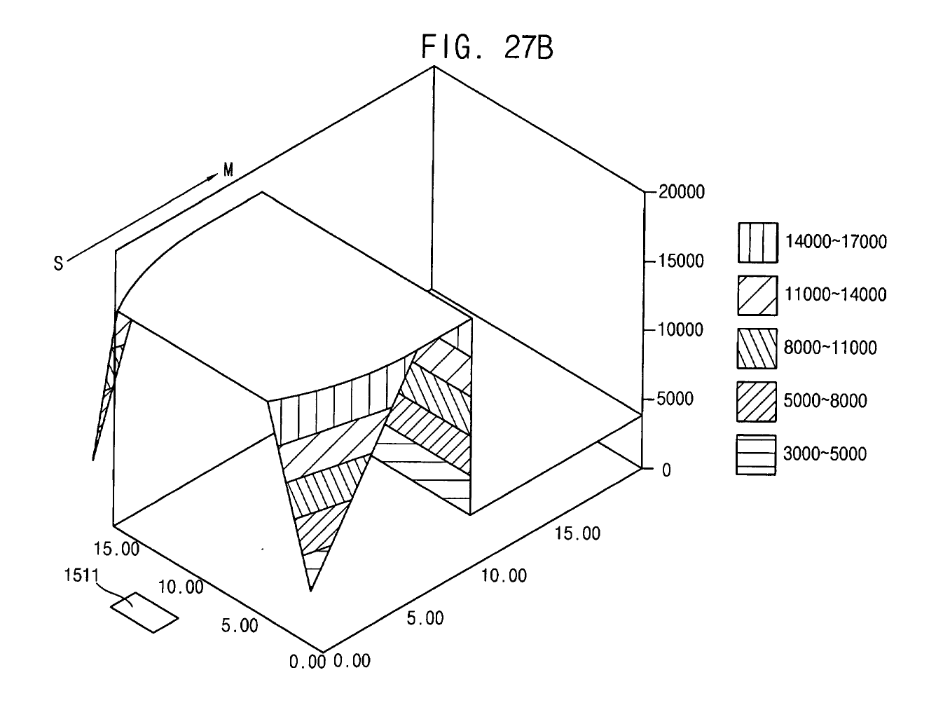

FIG. 27A is an image illustrating a luminance of a light exiting an exemplary light guiding unit when an exemplary LED is adjacent to a main region of the light guiding unit. FIG. 27B is an image illustrating a luminance of a light exiting an exemplary light guiding unit when an exemplary LED is adjacent to a sub region of the light guiding unit. In FIGS. 27A and 27B, the luminance of the light having passed through the light guiding unit 1540 is generated from the LED 1511 based on the second electric current in the constant-state driving mode.

Referring to FIGS. 27A, when the LED 1511 is adjacent to the main region MS, the luminance of the main region MS is greater than that of the sub region SS so that the image display quality of the sub region SS is deteriorated.

However, in FIGS. 27B, when the LED 1511 is adjacent to the sub region SS, the luminance of the sub region SS is increased, thereby improving the image display quality of the sub region SS. For example, the luminance of the sub region SS shown in FIG. 27B is greater than that of the sub region shown in FIG. 27A by about 30%.

In view of the above-described exemplary embodiments of backlight assemblies and display devices, a method of controlling luminance in a display panel having a sub display part and a main display part in accordance with exemplary embodiments of the present invention includes providing a luminance enhancing element relative to a sub region of a light guiding unit in a backlight assembly and reducing power consumption in the backlight assembly from a first level during a selective-state driving mode to a second level during a constant-state driving mode, wherein luminance of the sub display part is not substantially reduced during the constant-state driving mode.

Providing a luminance enhancing element may include, for example, forming an optical pattern on the sub region but not on the main region of the light guiding unit, disposing a second optical sheet in an area corresponding to the sub region of the light guiding unit but not in an area corresponding to a main region of the light guiding unit, or arranging a light source adjacent the sub region of the light guiding unit. In the case of arranging a light source, the method may further include providing a first electric power to the light source in the selective-state driving mode and a lower second electric power to the light source in the constant-state driving mode. A light source may further be arranged adjacent a main region of the light guiding unit, and the method may further include applying a first electric power to the light source adjacent the main region during the selective state driving mode, and applying a second electric power to the light source adjacent the sub region during the constant-state driving mode.

According to exemplary embodiments of the present invention, an optical pattern is formed on a sub region of a light exiting surface of a light guiding unit to increase the luminance of the sub region. In addition, a light scattering pattern or a brightness enhancement pattern may be formed on a corresponding surface of the light guiding unit.

Alternatively, the backlight assembly may have an optical sheet having various structures corresponding to the main and sub regions, respectively. In addition, the backlight assembly may include a light source corresponding to the main region and a light source corresponding to the sub region. In other alternative embodiments, the light source may be only on the sub region to decrease the power consumption of the backlight assembly.

Therefore, the luminance of the sub region in the constant-state driving mode is increased, and the power consumption of the backlight assembly is decreased.

In addition, exemplary embodiments of a display device include the various exemplary embodiments of the backlight assembly so that the luminance of the sub image displayed on the sub display part of a display panel of the display device is increased. The image display quality of the sub data that is constantly displayed on the sub display region is improved, and the power consumption of the display device is decreased.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly supplying a guided light to a display panel having a main display part on which a main image is selectively displayed, and a sub display part on which a sub image is constantly displayed, the backlight assembly comprising:
a light source generating a light; and
a light guiding unit including:
a light incident surface into which the light from the light source is incident;
a light exiting surface having a main region and a sub region, the sub region having an optical pattern increasing a luminance of the light from the light source, the guided light exiting the light exiting surface; and
a corresponding surface corresponding to the light exiting surface.

2. The backlight assembly of claim 1, wherein the optical pattern comprises a plurality of first prisms.

3. The backlight assembly of claim 2, wherein the plurality of first prisms have a substantially triangular shape.

4. The backlight assembly of claim 2, wherein a plurality of second prisms is formed on the corresponding surface.

5. The backlight assembly of claim 1, wherein the main region has a substantially flat surface.

6. The backlight assembly of claim 1, wherein the main region is adjacent the light incident surface, and the sub region is spaced apart from the light incident surface.

7. The backlight assembly of claim 1, wherein the corresponding surface is a light reflecting surface.

8. The backlight assembly of claim 1, wherein the optical pattern comprises a plurality of embossing patterns.

9. The backlight assembly of claim 1, wherein a light scattering pattern is formed on the corresponding surface, and the light scattering pattern corresponding to the main region has a lower density than the light scattering pattern corresponding to the sub region.

10. A backlight assembly supplying a guided light to a display panel having a main display part on which a main image is selectively displayed, and a sub display part on which a sub image is constantly displayed, the backlight assembly comprising:
a light source generating a light;
a light guiding unit including a light incident surface into which the light from the light source is incident, and a light exiting surface having a main region and a sub region, the guided light exiting the light exiting surface;
a first optical sheet on the main region increasing a luminance of the guided light exiting the main region by a first luminance increasing ratio; and
a second optical sheet on the sub region increasing a luminance of the guided light exiting the sub region by a second luminance increasing ratio that is greater than the first luminance increasing ratio.

11. The backlight assembly of claim 10, wherein the first optical sheet also covers the sub region, and the second optical sheet overlaps the first optical sheet.

12. The backlight assembly of claim 11, wherein the second optical sheet comprises a dual brightness enhancement film.

13. The backlight assembly of claim 11, wherein the first optical sheet comprises:
a diffusion sheet diffusing the guided light to increase a luminance uniformity; and
a first brightness enhancement sheet increasing a luminance of diffused light from the diffusion sheet when viewed on a plane.

14. The backlight assembly of claim 13, wherein the second optical sheet comprises a second brightness enhancement sheet having a different longitudinal direction from the first brightness enhancement sheet.

15. A backlight assembly supplying a guided light to a display panel having a main display part on which a main image is selectively displayed, and a sub display part on which a sub image is constantly displayed, the backlight assembly comprising:
a first light source generating a first light in a selective-state driving mode, the first light source adjacent to the main display part;
a second light source generating a second light in a constant-state driving mode, the second light source adjacent to the sub display part; and
a light guiding unit guiding the first and second lights and supplying the display panel with the guided light.

16. The backlight assembly of claim 15, wherein the light guiding unit comprises:
a light exiting surface including a main region corresponding to the main display part and a sub region corresponding to the sub display part;
a first side surface connected to the main region and adjacent to the first light source; and
a second side surface connected to the sub region and adjacent to the second light source.

17. The backlight assembly of claim 15, wherein the light guiding unit comprises:
a main light guiding plate corresponding to the main display part and adjacent to the first light source; and
a sub light guiding plate corresponding to the sub display part and adjacent to the second light source.

18. The backlight assembly of claim 17, wherein the light guiding unit further comprises a reflecting layer interposed between the main and sub light guiding plates, optically insulating the main light guiding plate from the sub light guiding plate.

19. The backlight assembly of claim 15, further comprising optical sheets on the light guiding unit increasing a luminance uniformity and a luminance when viewed on a plane.

20. The backlight assembly of claim 15, wherein each of the first and second light sources comprises a light-emitting diode.

21. A display device comprising:
a light source generating a light; and
a light guiding unit including:
a light incident surface into which the light is incident; and
a light exiting surface having a main region and a sub region, the sub region having an optical pattern increasing a luminance of the light, a guided light exiting the light exiting surface; and
a display panel having a main display part on which a main image is displayed based on the guided light exiting the main region of the light exiting surface, and a sub display part on which a sub image is displayed based on the guided light exiting the sub region of the light exiting surface.

22. The display device of claim 21, wherein a light scattering pattern is formed on a corresponding surface corresponding to the light exiting surface, and the light scattering pattern corresponding to the main region has a lower density than the light scattering pattern corresponding to the sub region.

23. A display device comprising:
a light source generating a light;
a light guiding unit including a light incident surface into which the light is incident, and a light exiting surface having a main region and a sub region, a guided light exiting the light exiting surface;
a first optical sheet on the main and sub regions increasing a luminance of the guided light exiting the main and sub regions by a first luminance increasing ratio;
a second optical sheet on the sub region increasing a luminance of the guided light exiting the sub region by a second luminance increasing ratio that is greater than the first luminance increasing ratio; and
a display panel having a main display part on which a main image is displayed based on the guided light exiting the main region of the light exiting surface, and a sub display part on which a sub image is displayed based on the guided light exiting the sub region of the light exiting surface.

24. The display device of claim 23, wherein the first optical sheet comprises:
a diffusion sheet diffusing the guided light exiting the light exiting surface to increase a luminance uniformity; and
a first brightness enhancement sheet increasing a luminance of diffused light from the diffusion sheet when viewed on a plane.

25. The display device of claim 24, wherein the second optical sheet comprises at least one of a dual brightness enhancement film and a second brightness enhancement sheet.

26. A display device comprising:
a display panel including a main display part on which a main image is selectively displayed, and a sub display part on which a sub image is constantly displayed;
a backlight assembly including:
a first light source adjacent to the main display part and generating a first light;
a second light source adjacent to the sub display part and generating a second light; and
a light guiding unit guiding the first and second lights toward the display panel; and
a driving circuit part applying an electric power to the first light source in a selective-state driving mode, and applying an electric power to the second light source in a constant-state driving mode.

27. The display device of claim 26, wherein the driving circuit part is electrically connected to the display panel, and the driving circuit part applies a first driving signal to the display panel in the selective-state driving mode to display the main image, and applies a second driving signal to the display panel in the constant-state driving mode to display the sub image.

28. The display device of claim 26, wherein the light guiding unit comprises:
a first side surface adjacent to the first light source;
a second side surface adjacent to the second light source; and
a light exiting surface connected between the first and second side surfaces, guided first and second lights exiting the light exiting surface.

29. The display device of claim 26, wherein the light guiding unit comprises:
a main light guiding plate corresponding to the main display part adjacent to the first light source; and
a sub light guiding plate corresponding to the sub display part adjacent to the second light source.

30. A display device comprising:
a display panel including a main display part on which a main image is selectively displayed, and a sub display part on which a sub image is constantly displayed;
a backlight assembly including:
a point light source adjacent to the sub display part and generating a light; and
a light guiding unit guiding the light toward the display panel; and
a driving circuit part applying a first electric power to the point light source in a selective-state driving mode, and applying a second electric power to the point light source in a constant-state driving mode.

31. The display device of claim 30, wherein the main display part displays the main image in the selective-state driving mode, and the sub display part displays the sub image in the constant-state driving mode.

32. The display device of claim 30, wherein the light guiding unit comprises:
a light exiting surface having a main region corresponding to the main display part and a sub region corresponding to the sub display part; and
a side surface connected to the sub region of the light exiting surface adjacent to the point light source.

33. A method of controlling luminance in a display panel having a sub display part and a main display part, the method comprising:
providing a luminance enhancing element relative to a sub region of a light guiding unit in a backlight assembly; and
reducing power consumption in the backlight assembly from a first level during a selective-state driving mode to a second level during a constant-state driving mode;
wherein luminance of the sub display part is not substantially reduced during the constant-state driving mode.

34. The method of claim 33, wherein the providing the luminance enhancing element includes forming an optical pattern on the sub region but not on a main region of the light guiding unit.

35. The method of claim 33, further comprising providing a first optical sheet between the light guiding unit and the display panel, and wherein the providing the luminance enhancing element includes disposing a second optical sheet in an area corresponding to the sub region of the light guiding unit but not in an area corresponding to a main region of the light guiding unit.

36. The method of claim 33, wherein the providing the luminance enhancing element includes arranging a light source adjacent the sub region of the light guiding unit.

37. The method of claim 36, further comprising providing a first electric power to the light source in the selective-state driving mode and a lower second electric power to the light source in the constant-state driving mode.

38. The method of claim 36, further comprising arranging a light source adjacent a main region of the light guiding unit, applying a first electric power to the light source adjacent the main region during the selective state driving mode, and applying a second electric power to the light source adjacent the sub region during the constant-state driving mode.
